(19) United States
(12) Patent Application Publication
(10) Pub. No.: US 2014/0113824 A1
(43) Pub. Date: Apr. 24, 2014

(54) BICYCLIC (THIO)CARBONYLAMIDINES

(71) Applicant: BAYER INTELLECTUAL PROPERTY GMBH, Monheim (DE)

(72) Inventors: Peter Jeschke, Bergisch Gladbach (DE); Michael Schindler, Bergisch Gladbach (DE); Katharina Wölfel, Langenfeld (DE); Ulrich Ebbinghaus-Kintscher, Dortmund (DE); Arnd Voerste, Koln (DE); Olga Malsam, Roesrath (DE); Peter Losel, Leverkusen (DE); Ulrich Görgens, Ratingen (DE)

(21) Appl. No.: 14/114,631

(22) PCT Filed: May 7, 2012
(86) PCT No.: PCT/EP2012/058340

§ 371 Date: Dec. 16, 2013

(30) Foreign Application Priority Data
May 10, 2011 (EP) 11165556.9

(51) Int. Cl. A01N 43/90

(52) U.S. Cl. CPC A01N 43/90
USPC 504/235; 546/116; 514/302; 504/246; 514/255.05; 544/405

(57) ABSTRACT

Bicyclic (thio)carbonylamidines of the formula (I)

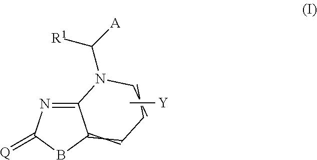

in which Q, B, Y, R¹ and A are as defined in the description
their preparation and their use for controlling plant pests and pests encountered in veterinary medicine.

The invention relates to novel compounds, to their preparation and to their use for controlling plant pests and pests encountered in veterinary medicine.

Cyclic carbonylamidines, which are used as intermediates for the preparation of insecticidal compounds, are known from WO 2002/085870 A1. WO 2002/085870 A1 describes compounds of the structure below, in publication referred to as formula (Va):

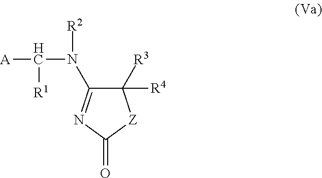

in which
Z represents O or CH₂;
A represents in each case optionally substituted aryl, hetaryl or heterocyclyl, in particular thiazolyl or pyridyl, which are in each case optionally substituted by halogen (in particular chlorine) or C₁-C₃-alkyl (in particular methyl); and R¹, R², R³ and R⁴ independently of one another represent hydrogen or C₁-C₃-alkyl.

WO 2010/005692 A2 discloses that certain cyclic carbonylamidines, among others those encompassed by the general formula (Va) as described in WO 2002/085870 A1, have biological activity, and that they can be used for controlling insects. WO 2010/005692 A2 also describes the preparation of such compounds.

Furthermore, WO 2007/115647 A1 describes, in a general manner, bicyclic enamino(thio)carbonyl compounds which are said to have insecticidal action. WO 2007/115647 A1 describes, in detail, compounds in which the carbon atoms of the 5-, 6- or 7-membered ring fused to the furanone are only partially unsaturated. The publication does not disclose any compounds in which the fused rings are fully unsaturated.

In addition, the patent CH 461489 discloses that certain bicyclic carbonylamidines, for example 4-(fur-2-ylmethyl)oxazolo[4,5-b]pyridin-2(4H)-one, 4-(thien-2-ylmethyl)oxazolo[4,5-b]pyridin-2(4H)-one or 4-(pyridin-2-ylmethyl)oxazolo[4,5-b]pyridin-2(4H)-one, have pharmaceutical activity, namely analgetic, antiinflammatory, antipyretic, spasmolytic and local anesthetic activity.

However, since the ecological and economic demands made on modern crop protection agents are increasing constantly, for example with respect to selectivity and application rate, and there can furthermore be problems, for example with resistances, there is a constant need to develop novel crop protection agents which, at least in some areas, have advantages over the known ones.

Accordingly, it is an object of the present invention to provide compounds having biological activity, preferably insecticidal activity.

The inventors have found novel bicyclic (thio)carbonylamidines which have good biological activity and other advantages.

Accordingly, the application provides bicyclic (thio)carbonylamidines of the formula (I)

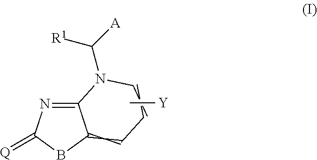

in which
Q represents oxygen or sulfur; with preference, Q represents oxygen;
B represents oxygen, sulfur, methylene, difluoromethylene, or optionally substituted nitrogen; with preference, B represents oxygen or methylene;
Y represents a radical selected from a group consisting of hydrogen, cyano, halogen (for example fluorine, chlorine, bromine or iodine), C₁-C₆-alkoxy, C₁-C₆-haloalkoxy, C₁-C₆-alkylthio, C₁-C₆-haloalkylthio, C₁-C₆-alkylsulfinyl, C₁-C₆-haloalkylsulfinyl, C₁-C₆-alkylsulfonyl and C₁-C₆-haloalkylsulfonyl, C₁-C₆-alkyl, C₁-C₆-haloalkyl, C₂-C₆-alkenyl, C₂-C₆-haloalkenyl, C₂-C₆-alkynyl, C₂-C₆-haloalkynyl, nitro, amino, C₁-C₆-alkylamino, di(C₁-C₆-alkyl)amino, C₁-C₆-alkylcarbonylamino, C₁-C₆-alkoxycarbonylamino, C₃-C₆-cycloalkyl-C₁-C₆-alkyl, C₃-C₆-cycloalkyl, C₁-C₆-alkylcarbonyl and C₁-C₆-alkoxycarbonyl; with preference, Y represents hydrogen or halogen, in particular fluorine;
R¹ represents hydrogen or C₁-C₆-alkyl; with preference, R¹ represents hydrogen;
A represents a hetaryl radical selected from a group consisting of pyrrolyl, pyrazolyl, imidazolyl, 1,2,3-triazolyl, 1,2,4-triazolyl, tetrazolyl, oxazolyl, isoxazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, 1,2,5-thiadiazolyl, pyridyl, pyrimidinyl, pyridazinyl, pyrazinyl, where each of these hetaryl radicals may be substituted by at least one substituent X selected from a group consisting of fluorine, chlorine, bromine, iodine, cyano, nitro, C₁-C₄-alkyl, C₁-C₄-haloalkyl (preferably C₁-C₄-fluoroalkyl, C₁-C₄-chloroalkyl or C₁-C₄-fluorochloroalkyl), C₁-C₃-alkylthio, C₁-C₃-haloalkylthio (preferably C₁-C₃-fluoroalkylthio, C₁-C₃-chloroalkylthio or C₁-C₃-fluorochloroalkylthio), C₁-C₃-alkylsulfonyl, C₁-C₃-haloalkylsulfonyl (preferably C₁-C₃-fluoroalkylsulfonyl, C₁-C₃-chloroalkylsulfonyl or C₁-C₃-fluorochloroalkylsulfonyl), or represents heterocyclyl from the group consisting of tetrahydrofur-3-yl or tetrahydrothien-3-yl; preferably, A represents thiazol-5-yl which is substituted in the 2-position by fluorine, chlorine, bromine, iodine, C₁-C₄-alkyl or C₁-C₄-haloalkyl, represents isoxazol-5-yl which is substituted in the 3-position by fluorine, chlorine, bromine, iodine, C₁-C₄-alkyl, C₁-C₄-haloalkyl, C₁-C₄-haloalkoxy or cyano, represents oxazol-5-yl which is substituted in the 2-position by fluorine, chlorine, bromine, iodine, C₁-C₄-alkyl, C₁-C₄-haloalkyl, C₁-C₄-haloalkoxy or cyano, represents 1,2,5-thiadiazol-3-yl or represents tetrahydrofur-3-yl, pyrid-3-yl which is substituted in the 6-position by fluorine, chlorine, bromine, iodine, C₁-C₄-alkyl or C₁-C₄-haloalkyl, pyrimidin-5-yl which is substituted in the 2-position by fluorine, chlorine, bromine, iodine oder C₁-C₄-alky, pyrazin-2-yl which is substituted in the 2-position by fluorine, chlorine, bromine, iodine or C₁-C₄-alkyl or represents pyrid-3-yl which is substituted in the 5-position by fluorine, chlorine, bromine, iodine, C₁-C₄-alkyl, C₁-C₄-haloalkyl, C₁-C₄-haloalkoxy, azido or cyao and is substituted in the 6-position by fluorine, chlorine, bromine, iodine, C₁-C₄-alkyl or C₁-C₄-haloalkyl; particularly preferably, A represents 6-chloropyrid-3-yl, 6-Ttrifluoromethylpyrid-3-yl, 6-fluoropyrid-3-yl, 6-bromopyrid-3-yl, 1,2,5-thiadiazol-3-yl, 5-methylpyrazin-2-yl, 2-chloro-1,3-thiazol-5-yl, 2-methyl-1,3-thiazol-5-yl, 2-methoxy-1,3-thiazol-5-yl, 2-bromo-1,3-thiazol-5-yl, 3-trifluoromethyl-1,3-thiazol-5-yl, 3-chloroisoxazol-5-yl, 3-methylisoxazol-5-yl, tetrahydrofur-3-yl, 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl or 5-difluoromethyl-6-iodopyrid-3-yl,
   where the substructure for

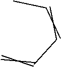

represents a system which optionally comprises at least one double bond, where the bond between the crossed line is a double bond or one or more of the crossed lines are double bonds,
with the proviso that the compound 4-(2′-pyridylmethyl)oxazolo[4,5-b]pyridin-2-(4H)-one, which is known from CH 461 489, is excluded.

The double bonds can also be conjugated, thus forming an aromatic system.

The invention furthermore provides bicyclic (thio)carbonylamidines having one of the formulae (I-a) to (I-q) in which R¹, A, Y, B and Q have the meanings mentioned in the present application:

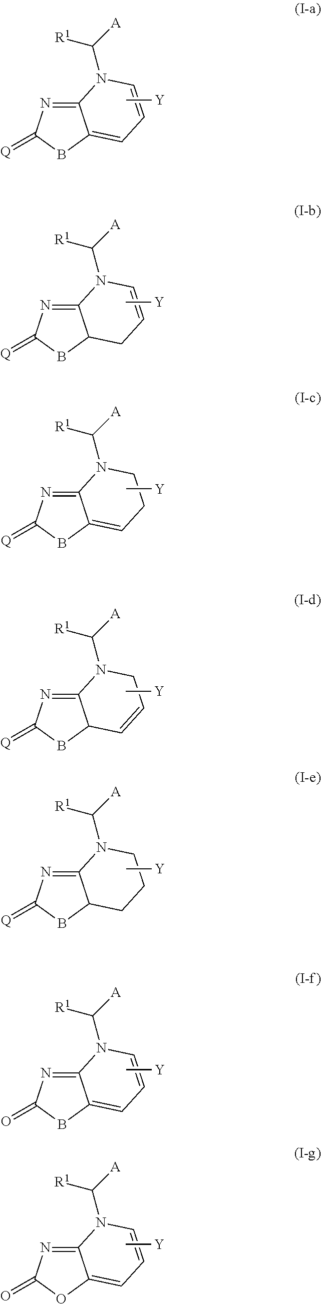

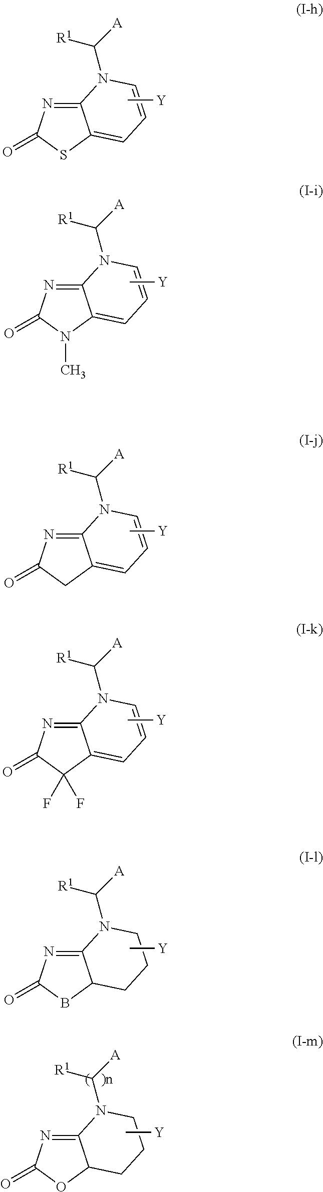

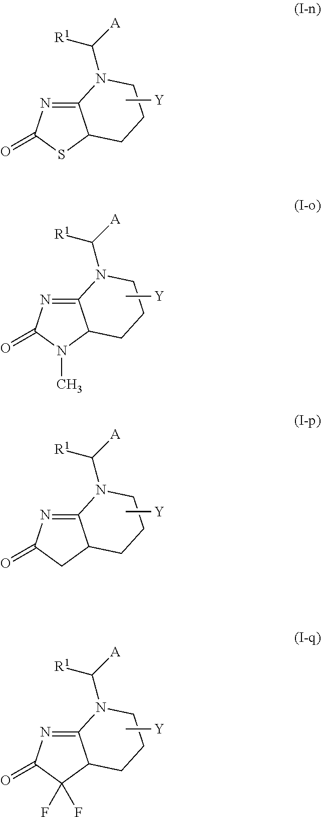

According to the invention, preference is given to bicyclic (thio)carbonylamidines of the formulae (I-a), (I-b), (I-c), (I-d) or (I-e) in which
R¹ represents hydrogen or C₁-C₆-alkyl; R¹ preferably represents hydrogen;
A represents a hetaryl radical selected from a group consisting of pyrrolyl, pyrazolyl, imidazolyl, 1,2,3-triazolyl, 1,2,4-triazolyl, tetrazolyl, oxazolyl, isoxazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, 1,2,5-thiadiazolyl, pyridyl, pyrimidinyl, pyridazinyl, pyrazinyl, where each of these hetaryl radicals may be substituted by at least one substituent X selected from a group consisting of fluorine, chlorine, bromine, iodine, cyano, nitro, C₁-C₄ alkyl, C₁-C₄-haloalkyl (preferably C₁-C₄-fluoroalkyl, C₁-C₄-chloroalkyl or C₁-C₄-fluorochloroalkyl), C₁-C₃-alkylthio, C₁-C₃-haloalkylthio (preferably C₁-C₃-fluoroalkylthio, C₁-C₃-chloroalkylthio or C₁-C₃-fluorochloroalkylthio), C₁-C₃-alkylsulfonyl, C₁-C₃-haloalkylsulfonyl (preferably C₁-C₃-fluoroalkylsulfonyl, C₁-C₃-chloroalkylsulfonyl or C₁-C₃-fluorochloroalkylsulfonyl), or represents heterocyclyl from the group consisting of tetrahydrofur-3-yl or tetrahydrothien-3-yl; preferably, A represents pyrazin-2-yl, thiazol-5-yl, isoxazol-5-yl, 1,2,5-thiadiazol-3-yl, tetrahydrofur-3-yl, pyridyl or pyrimidinyl which are optionally substituted by at least one substituent X selected from the group consisting of fluorine, chlorine, bromine, iodine, C₁-C₄-alkyl, C₁-C₄-haloalkyl; A particularly preferably represents thiazol-5-yl which is substituted in the 2-position by fluorine, chlorine, bromine, iodine, C₁-C₄-alkyl or C₁-C₄-haloalkyl, pyrid-3-yl which is substituted in the 6-position by fluorine, chlorine, bromine, iodine, C₁-C₄-alkyl or C₁-C₄-haloalkyl, pyrimidin-5-yl which is substituted in the 2-position by fluorine, chlorine, bromine, iodine or C₁-C₄-alkyl, pyrazin-2-yl which is substituted in the 2-position by fluorine, chlorine, bromine, iodine or C₁-C₄-alkyl or represents pyrid-3-yl which is substituted in the 5-position by fluorine, chlorine, bromine, iodine, C₁-C₄-alkyl, C₁-C₄-haloalkyl, C₁-C₄-haloalkoxy, azido or cyano and in the 6-position by fluorine, chlorine, bromine, iodine, C₁-C₄-alkyl or C₁-C₄-haloalkyl; furthermore particularly preferably, A is selected from a group consisting of 6-chloropyrid-3-yl, 6-trifluoromethylpyrid-3-yl, 6-fluoropyrid-3-yl, 6-bromopyrid-3-yl, 1,2,5-thiadiazol-3-yl, 5-methylpyrazin-2-yl, 2-chloro-1,3-thiazol-5-yl, 2-methyl-1,3-thiazol-5-yl, 2-methoxy-1,3-thiazol-5-yl, 2-bromo-1,3-thiazol-5-yl, 3-trifluoromethyl-1,3-thiazol-5-yl, 3-chloroisoxazol-5-yl, 3-methylisoxazol-5-yl, tetrahydrofur-3-yl, 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl and 5-difluoromethyl-6-iodopyrid-3-yl;
Y represents a radical selected from a group consisting of hydrogen, cyano, halogen (i.e. fluorine, chlorine, bromine or iodine), C₁-C₆-alkoxy, C₁-C₆-haloalkoxy, C₁-C₆-alkylthio, C₁-C₆-haloalkylthio, C₁-C₆-alkylsulfinyl, C₁-C₆-haloalkylsulfinyl, C₁-C₆-alkylsulfonyl and C₁-C₆-haloalkylsulfonyl, C₁-C₆-alkyl, C₁-C₆-haloalkyl, C₂-C₆-alkenyl, C₂-C₆-haloalkenyl, C₂-C₆-alkynyl, C₂-C₆-haloalkynyl, nitro, amino, C₁-C₆-alkylamino, di(C₁-C₆-alkyl)amino, C₁-C₆-alkylcarbonylamino, C₁-C₆-alkoxycarbonylamino, C₃-C₆-cycloalkyl-C₁-C₆-alkyl, C₃-C₆-cycloalkyl, C₁-C₆-alkylcarbonyl and C₁-C₆-alkoxycarbonyl; Y preferably represents hydrogen, cyano, halogen (for example fluorine, chlorine, bromine or iodine), C₁-C₆-haloalkyl or nitro; Y preferably represents hydrogen or halogen (in particular fluorine);
Q represents oxygen or sulfur; Q preferably represents oxygen; and
B represents oxygen, sulfur, methylene, difluoromethylene, or optionally substituted nitrogen; B preferably represents oxygen or methylene.

Preference according to the invention is likewise given to bicyclic (thio)carbonylamidines of the formulae (I-f) or (I-l) in which
R¹ represents hydrogen or C₁-C₆-alkyl; R¹ preferably represents hydrogen;
A represents a hetaryl radical selected from a group consisting of pyrrolyl, pyrazolyl, imidazolyl, 1,2,3-triazolyl, 1,2,4-triazolyl, tetrazolyl, oxazolyl, isoxazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, 1,2,5-thiadiazolyl, pyridyl, pyrimidinyl, pyridazinyl, pyrazinyl, where each of these hetaryl radicals may be substituted by at least one substituent X selected from a group consisting of fluorine, chlorine, bromine, iodine, cyano, nitro, C₁-C₄-alkyl, C₁-C₄-haloalkyl (preferably C₁-C₄-fluoroalkyl, C₁-C₄-chloroalkyl or C₁-C₄-fluorochloroalkyl), C₁-C₃-alkylthio, C₁-C₃-haloalkylthio (preferably C₁-C₃-fluoroalkylthio, C₁-C₃-chloroalkylthio or C₁-C₃-fluorochloroalkylthio), C₁-C₃-alkylsulfonyl, C₁-C₃-haloalkylsulfonyl (preferably C₁-C₃-fluoroalkylsulfonyl, C₁-C₃-chloroalkylsulfonyl or C₁-C₃-fluorochloroalkylsulfonyl), or represents heterocyclyl from the group consisting of tetrahydrofur-3-yl or tetrahydrothien-3-yl; preferably, A represents pyrazin-2-yl, thiazol-5-yl, isoxazol-5-yl, 1,2,5-thiadiazol-3-yl, tetrahydrofur-3-yl, pyridyl or pyrimidinyl which are optionally substituted by at least one substituent X selected from the group consisting of fluorine, chlorine, bromine, iodine, C₁-C₄-alkyl, C₁-C₄-haloalkyl; A particularly preferably represents thiazol-5-yl which is substituted in the 2-position by fluorine, chlorine, bromine, iodine, C₁-C₄-alkyl or C₁-C₄-haloalkyl, pyrid-3-yl which is substituted in the 6-position by fluorine, chlorine, bromine, iodine, C₁-C₄-alkyl or C₁-C₄-haloalkyl, pyrimidin-5-yl which is substituted in the 2-position by fluorine, chlorine, bromine, iodine or C₁-C₄-alkyl, pyrazin-2-yl which is substituted in the 2-position by fluorine, chlorine, bromine, iodine or C₁-C₄-alkyl or represents pyrid-3-yl which is substituted in the 5-position by fluorine, chlorine, bromine, iodine, C₁-C₄-alkyl, C₁-C₄-haloalkyl, C₁-C₄-haloalkoxy, azido or cyano and in the 6-position by fluorine, chlorine, bromine, iodine, C₁-C₄-alkyl or C₁-C₄-haloalkyl; furthermore particularly preferably, A is selected from a group consisting of 6-chloropyrid-3-yl, 6-trifluoromethylpyrid-3-yl, 6-fluoropyrid-3-yl, 6-bromopyrid-3-yl, 1,2,5-thiadiazol-3-yl, 5-methylpyrazin-2-yl, 2-chloro-1,3-thiazol-5-yl, 2-methyl-1,3-thiazol-5-yl, 2-methoxy-1,3-thiazol-5-yl, 2-bromo-1,3-thiazol-5-yl, 3-trifluoromethyl-1,3-thiazol-5-yl, 3-chloroisoxazol-5-yl, 3-methylisoxazol-5-yl, tetrahydrofur-3-yl, 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl and 5-difluoromethyl-6-iodopyrid-3-yl;
Y represents a radical selected from a group consisting of hydrogen, cyano, halogen (i.e. fluorine, chlorine, bromine or iodine), C₁-C₆-alkoxy, C₁-C₆-haloalkoxy, C₁-C₆-alkylthio, C₁-C₆-haloalkylthio, C₁-C₆-alkylsulfinyl, C₁-C₆-haloalkylsulfinyl, C₁-C₆-alkylsulfonyl and C₁-C₆-haloalkylsulfonyl, C₁-C₆ alkyl, C₁-C₆-haloalkyl, C₂-C₆-alkenyl, C₂-C₆-haloalkenyl, C₂-C₆-alkynyl, C₂-C₆-haloalkynyl, nitro, amino, C₁-C₆-alkylamino, di(C₁-C₆-alkyl)amino, C₁-C₆-alkylcarbonylamino, C₁-C₆-alkoxycarbonylamino, C₃-C₆-cycloalkyl-C₁-C₆-alkyl, C₃-C₆-cycloalkyl, C₁-C₆-alkylcarbonyl and C₁-C₆-alkoxycarbonyl; Y preferably represents hydrogen, cyano, halogen (for example fluorine, chlorine, bromine or iodine), C₁-C₆-haloalkyl or nitro; Y preferably represents hydrogen or halogen, for example fluorine; and
B represents oxygen, sulfur, methylene, difluoromethylene, or optionally substituted nitrogen; B preferably represents oxygen or methylene in compounds of the formula (I-l) and B preferably represents oxygen in compounds of the formula (I-f).

Furthermore, preference according to the invention is likewise given to bicyclic (thio)carbonylamidines of the formulae (I-g), (I-h), (I-i), (I-j), (I-k), (I-m), (I-n), (I-o), (I-p) or (I-q) in which
R¹ represents hydrogen or C₁-C₆-alkyl; R¹ preferably represents hydrogen;
A represents a hetaryl radical selected from a group consisting of pyrrolyl, pyrazolyl, imidazolyl, 1,2,3-triazolyl, 1,2,4-triazolyl, tetrazolyl, oxazolyl, isoxazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, 1,2,5-thiadiazolyl, pyridyl, pyrimidinyl, pyridazinyl, pyrazinyl, where each of these hetaryl radicals may be substituted by at least one substituent X selected from a group consisting of fluorine, chlorine, bromine, iodine, cyano, nitro, C₁-C₄ alkyl, C₁-C₄-haloalkyl (preferably C₁-C₄-fluoroalkyl, C₁-C₄-chloroalkyl or C₁-C₄-fluorochloroalkyl), C₁-C₃-alkylthio, C₁-C₃-haloalkylthio (preferably C₁-C₃-fluoroalkylthio, C₁-C₃-chloroalkylthio or C₁-C₃-fluorochloroalkylthio), C₁-C₃-alkylsulfonyl, C₁-C₃-haloalkylsulfonyl (preferably C₁-C₃-fluoroalkylsulfonyl, C₁-C₃-chloroalkylsulfonyl or C₁-C₃-fluorochloroalkylsulfonyl), or represents heterocyclyl from the group consisting of tetrahydrofur-3-yl or tetrahydrothien-3-yl; preferably, A represents pyrazin-2-yl, thiazol-5-yl, isoxazol-5-yl, 1,2,5-thiadiazol-3-yl, tetrahydrofur-3-yl, pyridyl or pyrimidinyl which are optionally substituted by at least one substituent X selected from the group consisting of fluorine, chlorine, bromine, iodine, C₁-C₄-alkyl, C₁-C₄-haloalkyl; A particularly preferably represents thiazol-5-yl which is substituted in the 2-position by fluorine, chlorine, bromine, iodine, C₁-C₄-alkyl or C₁-C₄-haloalkyl, pyrid-3-yl which is substituted in the 6-position by fluorine, chlorine, bromine, iodine, C₁-C₄-alkyl or C₁-C₄-haloalkyl, pyrimidin-5-yl which is substituted in the 2-position by fluorine, chlorine, bromine, iodine or C₁-C₄-alkyl, pyrazin-2-yl which is substituted in the 2-position by fluorine, chlorine, bromine, iodine or C₁-C₄-alkyl or represents pyrid-3-yl which is substituted in the 5-position by fluorine, chlorine, bromine, iodine, C₁-C₄-alkyl, C₁-C₄-haloalkyl, C₁-C₄-haloalkoxy, azido or cyano and in the 6-position by fluorine, chlorine, bromine, iodine, C₁-C₄-alkyl or C₁-C₄-haloalkyl; furthermore particularly preferably, A is selected from a group consisting of 6-chloropyrid-3-yl, 6-trifluoromethylpyrid-3-yl, 6-fluoropyrid-3-yl, 6-bromopyrid-3-yl, 1,2,5-thiadiazol-3-yl, 5-methylpyrazin-2-yl, 2-chloro-1,3-thiazol-5-yl, 2-methyl-1,3-thiazol-5-yl, 2-methoxy-1,3-thiazol-5-yl, 2-bromo-1,3-thiazol-5-yl, 3-trifluoromethyl-1,3-thiazol-5-yl, 3-chloroisoxazol-5-yl, 3-methylisoxazol-5-yl, tetrahydrofur-3-yl, 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl and 5-difluoromethyl-6-iodopyrid-3-yl;
Y represents a radical selected from a group consisting of hydrogen, cyano, halogen (i.e. fluorine, chlorine, bromine or iodine), C₁-C₆-alkoxy, C₁-C₆-haloalkoxy, C₁-C₆-alkylthio, C₁-C₆-haloalkylthio, C₁-C₆-alkylsulfinyl, C₁-C₆-haloalkylsulfinyl, C₁-C₆-alkylsulfonyl and C₁-C₆-haloalkylsulfonyl, C₁-C₆-alkyl, C₁-C₆-haloalkyl, C₂-C₆-alkenyl, C₂-C₆-haloalkenyl, C₂-C₆-alkynyl, C₂-C₆-haloalkynyl, nitro, amino, C₁-C₆-alkylamino, di(C₁-C₆-alkyl)amino, C₁-C₆-alkylcarbonylamino, C₁-C₆-alkoxycarbonylamino, C₃-C₆-cycloalkyl-C₁-C₆-alkyl, C₃-C₆-cycloalkyl, C₁-C₆-alkylcarbonyl and C₁-C₆-alkoxycarbonyl; Y preferably represents hydrogen, cyano, halogen (for example fluorine, chlorine, bromine or iodine), C₁-C₆-haloalkyl or nitro; Y preferably represents hydrogen or halogen such as, for example, fluorine.

Furthermore, preference according to the invention is given to bicyclic (thio)carbonylamidines of the formula (I-g-1) below

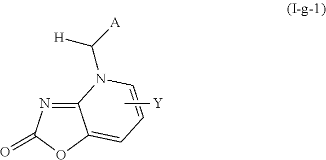

in which
Y represents a radical selected from a group consisting of hydrogen, cyano, halogen (i.e. fluorine, chlorine, bromine or iodine), C₁-C₆-alkoxy, C₁-C₆-haloalkoxy, C₁-C₆-alkylthio, C₁-C₆-haloalkylthio, C₁-C₆-alkylsulfinyl, C₁-C₆-haloalkylsulfinyl, C₁-C₆-alkylsulfonyl and C₁-C₆-haloalkylsulfonyl, C₁-C₆-alkyl, C₁-C₆-haloalkyl, C₂-C₆-alkenyl, C₂-C₆-haloalkenyl, C₂-C₆-alkynyl, C₂-C₆-haloalkynyl, nitro, amino, C₁-C₆-alkylamino, di(C₁-C₆-alkyl)amino, C₁-C₆-alkylcarbonylamino, C₁-C₆-alkoxycarbonylamino, C₃-C₆-cycloalkyl-C₁-C₆-alkyl, C₃-C₆-cycloalkyl, C₁-C₆-alkylcarbonyl and C₁-C₆-alkoxycarbonyl; Y preferably represents hydrogen, cyano, halogen (for example fluorine, chlorine, bromine or iodine), C₁-C₆-haloalkyl or nitro; Y preferably represents hydrogen or halogen, for example fluorine; and
A represents heteroaryl selected from a group consisting of 6-chloropyrid-3-yl, 6-trifluoromethylpyrid-3-yl, 6-fluoropyrid-3-yl, 6-bromopyrid-3-yl, 1,2,5-thiadiazol-3-yl, 5-methylpyrazin-2-yl, 2-chloro-1,3-thiazol-5-yl, 2-bromo-1,3-thiazol-5-yl, 2-methyl-1,3-thiazol-5-yl, 2-methoxy-1,3-thiazol-5-yl, 2-trifluoromethyl-1,3-thiazol-5-yl, 2-methyloxazol-5-yl, 2-chlorooxazol-5-yl, 1,2,5-thiadiazol-3-yl, 5-chloro-1,2,4-thiadiazol-3-yl, 5-chloro-1,2,3-thiadiazol-4-yl, 3-chloroisoxazol-5-yl, 3-bromoisoxazol-5-yl, 3-methylisoxazol-5-yl, 3-trifluoromethylisoxazol-5-yl, (R,S)-tetrahydrofur-3-yl, (R,S)-tetrahydrothien-3-yl, 6-fluoropyridin-3-yl, 6-chloropyridin-3-yl, 6-bromopyridin-3-yl, 6-iodopyridin-3-yl, 6-trifluoromethylpyridin-3-yl, 6-methylpyridin-3-yl, 2-chloropyrimidin-5-yl, 2-methylpyrimidin-5-yl, 5-fluoro-6-chloropyrid-3-yl, 5,6-dichloropyrid-3-yl, 5-bromo-6-chloropyrid-3-yl, 5-methyl-6-chloropyrid-3-yl, 5-fluoro-6-bromopyrid-3-yl, 5-chloro-6-bromopyrid-3-yl, 5-chloro-6-iodopyrid-3-yl and 2-chloropyrazin-5-yl.

The bicyclic (thio)carbonylamidines according to the invention may, depending on the nature of the substituents, be in the form of geometric and/or optically active isomers or corresponding isomer mixtures of varying composition. These stereoisomers are, for example, enantiomers, diastereomers, atropisomers or geometric isomers. Accordingly, the invention encompasses pure stereoisomers and any mixture of these isomers.

If appropriate, the bicyclic (thio)carbonylamidines according to the invention may be present in various polymorphic forms or as mixtures of different polymorphic forms. Both the pure polymorphs and the polymorph mixtures are provided by the invention and can be used according to the invention.

The bicyclic (thio)carbonylamidines of the formula (I) according to the invention can be prepared by customary methods known to the person skilled in the art. Reaction Scheme 1 describes one possible way of preparation, which is also provided by the invention.

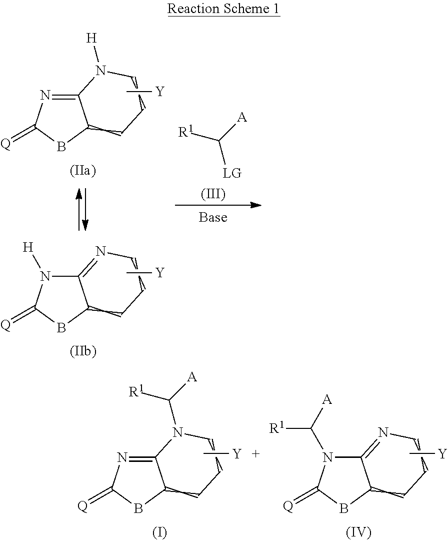

In Reaction Scheme 1, the groups R¹, A, Y, Q and B are as defined in the present application, and LG is a leaving group, in particular halogen, O-tosyl, O-mesyl, N-morpholino.

Thus, the invention also relates to a process for preparing bicyclic (thio)carbonylamidines of the formula (I) in which R¹, A, Y, Q and B have the meanings given above, in particular the meanings given in connection with compounds of substructure (I-a), (I-b), (I-c), (I-d) or (I-e), which process comprises reacting a compound of the formula (IIa) and/or (IIb), (generally referred to as compound of the formula (II)),

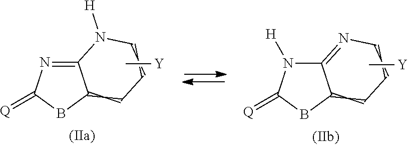

in which Q, B and Y have the meanings mentioned for the compounds of the formula (I), (I-a), (I-b), (I-c), (I-d) and (I-e)
with a compound of the formula (III)

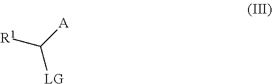

in which
R¹ and A have the meanings given for the compounds of the formula (I), (I-a), (I-b), (I-c), (I-d) and (I-e), (I-f), (I-g), (I-h), (I-j), (I-k), (I-l), (I-m), (I-n), (I-o), (I-p) and (I-q) and
LG represents a nucleofugic leaving group, optionally generated in situ, in particular halogen, (chlorine, bromine, iodine), O-tosyl, O-mesyl, N-morpholino.
in the presence of a diluent and optionally in the presence of a basic reaction auxiliary.

Suitable diluents (solvents) for carrying out the process according to the invention are all inert organic solvents. Diluents which are particularly suitable according to the invention are, for example, halogenated hydrocarbons, in particular chlorinated hydrocarbons, such as tetraethylene, tetrachloroethane, dichloropropane, methylene chloride, dichlorobutane, chloroform, carbon tetrachloride, trichloroethane, trichloroethylene, pentachloroethane, difluorobenzene, 1,2-dichloroethane, chlorobenzene, bromobenzene, dichlorobenzene, chlorotoluene, trichlorobenzene; alcohols such as methanol, ethanol, isopropanol, butanol; ethers such as ethyl propyl ether, methyl tert-butyl ether, n-butyl ether, anisole, phenetole, cyclohexyl methyl ether, dimethyl ether, diethyl ether, dipropyl ether, diisopropyl ether, di-n-butyl ether, diisobutyl ether, diisoamyl ether, ethylene glycol dimethyl ether, tetrahydrofuran, dioxane, dichlorodiethyl ether and polyethers of ethylene oxide and/or propylene oxide; amines such as trimethyl-, triethyl-, tripropyl-, tributylamine, N-methylmorpholine, pyridine and tetramethylenediamine; nitrohydrocarbons such as nitromethane, nitroethane, nitropropane, nitrobenzene, chloronitrobenzene, o-nitrotoluene; nitriles such as acetonitrile, propionitrile, butyronitrile, isobutyronitrile, benzonitrile, m-chlorobenzonitrile and compounds such as tetrahydrothiophene dioxide and dimethyl sulfoxide, tetramethylene sulfoxide, dipropyl sulfoxide, benzyl methyl sulfoxide, diisobutyl sulfoxide, dibutyl sulfoxide, diisoamyl sulfoxide; sulfones such as dimethyl, diethyl, dipropyl, dibutyl, diphenyl, dihexyl, methyl ethyl, ethyl propyl, ethyl isobutyl and pentamethylene sulfone; aliphatic, cycloaliphatic or aromatic hydrocarbons such as pentane, hexane, heptane, octane, nonane and industrial hydrocarbons; for example what are called “white spirits” with components having boiling points in the range from, for example, 40° C. to 250° C., cymene, petroleum fractions within a boiling range from 70° C. to 190° C., cyclohexane, methylcyclohexane, petroleum ether, ligroin, octane, benzene, toluene, chlorobenzene, bromobenzene, nitrobenzene, xylene; esters such as methyl, ethyl, butyl and isobutyl acetate, dimethyl, dibutyl and ethylene carbonate; amides such as hexamethylphosphoric triamide, formamide, N-methylformamide, N,N-dimethylformamide, N,N-dipropylformamide, N,N-dibutylformamide, N-methylpyrrolidine, N-methylcaprolactam, 1,3-dimethyl-3,4,5,6-tetrahydro-2(1H)-pyrimidine, octylpyrrolidone, octylcaprolactam, 1,3-dimethyl-2-imidazolinedione, N-formylpiperidine, N,N′-1,4-diformylpiperazine; and ketones such as acetone, acetophenone, methyl ethyl ketone, methyl butyl ketone. It is also possible to use, for the process according to the invention, mixtures of the diluents mentioned.

Preferred diluents for carrying out the process according to the invention are amides, formamide, N-methylformamide, N,N-dimethylformamide, N,N-dipropylformamide, N,N-dibutylformamide, N-methylpyrrolidine, in particular N,N-dimethylformamide.

Diluents are advantageously employed in such an amount that the reaction mixture remains readily stirrable during the entire process.

For carrying out the process according to the invention, about 0.3 to about 4.0 mol, preferably about 0.7 to about 3.0 mol, particularly preferably about 0.9 to about 1.5 mol of the compound of the formula (III) are employed per mole of the compound of the general formula (II).

Appropriate for use as basic reaction auxiliaries for carrying out the process according to the invention are all suitable acid binders, alone or as a mixture. Suitable acid binders are, for example, halides, hydroxides, hydrides, oxides and carbonates of lithium, sodium, potassium, magnesium, calcium and barium, in particular the carbonates and halides of alkali metals, in particular those of sodium, potassium or cesium, or basic compounds such as amidine bases or guanidine bases, such as 7-methyl-1,5,7-triazabicyclo [4.4.0]dec-5-ene (MTBD); diazabicyclo[4.3.0]nonene (DBN), diazabicyclo[2.2.2]octane (DABCO), 1,8-diazabicyclo[5.4.0]undecene (DBU), cyclohexyltetrabutylguanidine (CyTBG), cyclohexyltetramethylguanidine (CyTMG), N,N,N,N-tetramethyl-1,8-naphthalenediamine, pentamethylpiperidine, or tertiary amines such as triethylamine, trimethylamine, tribenzylamine, triisopropylamine, tributylamine, tricyclohexylamine, triamylamine, trihexylamine, N,N-dimethylaniline, N,N-dimethyltoluidine, N,N-dimethyl-p-aminopyridine, N-methylpyrrolidine, N-methylpiperidine, N-methylimidazole, N-methylpyrazole, N-methyl-morpholine, N-methylhexamethylenediamine, pyridine, 4-pyrrolidinopyridine, 4-dimethylaminopyridine, quinoline, α-picoline, β-picoline, isoquinoline, pyrimidine, acridine, N,N,N′,N′-tetramethylenediamine, N,N′,N′-tetraethylenediamine, quinoxaline, N-propyldiisopropylamine, N-ethyldiisopropylamine, N,N′-dimethylcyclohexylamine, 2,6-lutidine, 2,4-lutidine or triethyldiamine. Preference according to the invention is given to sodium carbonate, potassium carbonate, cesium carbonate, sodium halide (for example NaCl, NaF, NaI, NaBr), potassium halide (KCl, KF, KI, KBr), cesium halide (CsCl, CsF, CsI, CsBr) and mixtures thereof. Particular preference is given to a mixture of cesium carbonate and cesium iodide.

The reaction time is generally from 10 minutes to 72 hours. The reaction is carried out at temperatures in the range from −10° C. to +200° C., preferably from +10° C. to 120° C., particularly preferably from +10° C. to 40° C., very particularly preferably at room temperature (i.e. at about 20° C.).

In principle, the reaction can be carried out under atmospheric pressure. Preferably, the reaction is carried out at atmospheric pressure or at elevated pressure, for example from about 2 to 15 bar and optionally under an atmosphere of protective gas (for example nitrogen, helium or argon).

After the reaction has gone to completion, the entire reaction mixture is concentrated, i.e. the solvent is removed (distillatively) and the reaction mixture is worked up in a customary manner (for example aqueous). The products obtained after work-up can be purified in a customary manner by recrystallization, distillation under reduced pressure or column chromatography (cf. also the Preparation Examples).

Unless indicated otherwise, the general terms used here are defined as follows:

Unless indicated otherwise, the term “alkyl”, either alone or else in combination with other terms such as, for example haloalkyl, alkylthio, haloalkylsulfinyl, alkylsulfonyl, haloalkylsulfonyl, alkylamino, alkylcarbonylamino, alkylcarbonyl, or as the prefix “alk” in combination with other terms such as, for example, alkoxy, haloalkoxy, alkoxycarbonyl, alkoxycarbonylamino, is, in the context of the present invention, to be understood to mean a radical of a saturated aliphatic hydrocarbon group which has the appropriate number of carbon atoms and can be branched or straight-chain. Examples of C₁-C₆-alkyl radicals are methyl, ethyl, n-propyl, isopropyl, n-butyl, isobutyl, sec-butyl, tert-butyl, n-pentyl, isopentyl, neopentyl, tert-pentyl, 1-methylbutyl, 2-methylbutyl, 1-ethylpropyl, 1,2-dimethylpropyl and hexyl.

Halogen represents fluorine, chlorine, bromine or iodine.

In the context of the present invention, halogen-substituted radicals, for example haloalkyl, are to be understood to mean radicals which are mono- or polysubstituted by halogen up to the maximum possible number of substituents. In the case of polyhalogenation, the halogen atoms can be identical or different. Here, halogen represents fluorine, chlorine, bromine or iodine. Examples of halogen-substituted radicals are chloromethyl, bromomethoxy, dichloromethylthio, trichloromethyl, fluoromethyl, chlorofluoromethyl, dichlorofluoromethyl, trifluoromethyl, 2,2-difluoroethyl, difluoromethyl, trifluoromethoxy, difluoromethoxy.

Examples of C₁-C₄-fluoroalkyl are CF₃, CHF₂, CH₂F, CF₃CF₂, CH₂CF₃, CH₂CHF₂, CH₂CH₂F, CHFCF₃, CHFCHF₂, CHFCH₂F, CHFCF₃, CF₂CF₃, CF₂CHF₂, CF₂CH₂F and CF₂CF₃.

Examples of C₁-C₄-chloroalkyl are CCl₃, CHCl₂, CH₂F, CCl₃CCl₂, CH₂CCl₃, CH₂CHCl₂, CH₂CH₂Cl, CHClCCl₃, CHClCHCl₂, CHClCH₂Cl, CHClCCl₃, CCl₂CCl₃, CCl₂CHCl₂, CCl₂CH₂Cl and CCl₂CCl₃.

Unless indicated otherwise, the term “heteroaryl” or “hetaryl” refers to aromatic ring systems having at least one heteroatom, such as, for example, nitrogen, oxygen or sulfur. Heteroaryls according to the invention are, among others, pyrrole, pyrazole, imdidazole, triazole, tetrazole, oxazole, isoxazole, thiazole, isothiazole, oxadiazole, thiadiazole, pyridine, pyrimidine, pyridazine and pyrazine. The heteroaryls may be substituted by suitable substituents.

Optionally substituted radicals can be mono or polysubstituted, where in the case of polysubstitutions the substituents can be identical or different.

The compounds according to the invention, in combination with good plant tolerance and favorable toxicity to warm-blooded animals and being tolerated well by the environment, are suitable for protecting plants and plant organs, for increasing the harvest yields, for improving the quality of the harvested material and for controlling animal pests, in particular insects, arachnids, helminths, nematodes and molluscs, which are encountered in agriculture, in horticulture, in animal husbandry, in forests, in gardens and leisure facilities, in the protection of stored products and of materials, and in the hygiene sector. They can be used with preference as crop protection agents. They are effective against normally sensitive and resistant species and against all or some stages of development. The abovementioned pests include:

Pests from the phylum of: Arthropoda, especially from the class of the Arachnida, for example, Acarus spp., Aceria sheldoni, Aculops spp., Aculus spp., Amblyomma spp., Amphitetranychus viennensis, Argas spp., Boophilus spp., Brevipalpus spp., Bryobia praetiosa, Centruroides spp., Chorioptes spp., Dermanyssus gallinae, Dermatophagoides pteronyssius, Dermatophagoides farinae, Dermacentor spp., Eotetranychus spp., Epitrimerus pyri, Eutetranychus spp., Eriophyes spp., Halotydeus destructor, Hemitarsonemus spp., Hyalomma spp., Ixodes spp., Latrodectus spp., Loxosceles spp., Metatetranychus spp., Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vaejovis spp., Vasates lycopersici.

From the order of the Anoplura (Phthiraptera), for example, Damalinia spp., Haematopinus spp., Linognathus spp., Pediculus spp., Ptirus pubis, Trichodectes spp.

From the order of the Chilopoda, for example, Geophilus spp., Scutigera spp.

From the order of the Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptorhynchus lapathi, Cylindrocopturus spp., Dermestes spp., Diabrotica spp., Dichocrocis spp., Diloboderus spp., Epilachna spp., Epitrix spp., Faustinus spp., Gibbium psylloides, Hellula undalis, Heteronychus arator, Heteronyx spp., Hylamorpha elegans, Hylotrupes bajulus, Hypera postica, Hypothenemus spp., Lachnosterna consanguinea, Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllotreta spp., Popillia japonica, Premnotrypes spp., Prostephanus truncatus, Psylliodes spp., Ptinus spp., Rhizobius ventralis, Rhizopertha dominica, Sitophilus spp., Sphenophorus spp., Stegobium paniceum, Sternechus spp., Symphyletes spp., Tanymecus spp., Tenebrio molitor, Tribolium spp., Trogoderma spp., Tychius spp., Xylotrechus spp., Zabrus spp.

From the order of the Collembola, for example, Onychiurus armatus.

From the order of the Diplopoda, for example, Blaniulus guttulatus.

From the order of the Diptera, for example, Aedes spp., Agromyza spp., Anastrepha spp., Anopheles spp., Asphondylia spp., Bactrocera spp., Bibio hortulanus, Calliphora erythrocephala, Ceratitis capitata, Chironomus spp., Chrysomyia spp., Chrysops spp., Cochliomyia spp., Contarinia spp., Cordylobia anthropophaga, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hylemyia spp., Hyppobosca spp., Hypoderma spp., Liriomyza spp., Lucilia spp., Lutzomia spp., Mansonia spp., Musca spp., Nezara spp., Oestrus spp., Oscinella fit, Pegomyia spp., Phlebotomus spp., Phorbia spp., Phormia spp., Prodiplosis spp., Psila rosae, Rhagoletis spp., Sarcophaga spp., Simulium spp., Stomoxys spp., Tabanus spp., Tannia spp., Tetanops spp., Tipula spp.

From the order of the Heteroptera, for example, Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.

From the order of the Homoptera, for example, Acyrthosipon spp., Acrogonia spp., Aeneolamia spp., Agonoscena spp., Aleurodes spp., Aleurolobus barodensis, Aleurothrixus spp., Amrasca spp., Anuraphis cardui, Aonidiella spp., Aphanostigma pin, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Drosicha spp., Dysaphis spp., Dysmicoccus spp., Empoasca spp., Eriosoma spp., Erythroneura spp., Euscelis bilobatus, Ferrisia spp., Geococcus coffeae, Hieroglyphus spp., Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes spp., Trioza spp., Typhlocyba spp., Unaspis spp., Viteus vitifolii, Zygina spp.

From the order of the Hymenoptera, for example, Acromyrmex spp., Athalia spp., Atta spp., Diprion spp., Hoplocampa spp., Lasius spp., Monomorium pharaonis, Solenopsis invicta, Tapinoma spp., Vespa spp.

From the order of the Isopoda, for example, Armadillidium vulgare, Oniscus asellus and Porcellio scaber.

From the order of the Isoptera, for example, Coptotermes spp., Cornitermes cumulans, Cryptotermes spp., Incisitermes spp., Microtermes obesi, Odontotermes spp., Reticulitermes spp.

From the order of the Lepidoptera, for example, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Chematobia brumata, Chilo spp., Choristoneura spp., Clysia ambiguella, Cnaphalocerus spp., Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamestra brassicae, Mocis spp., Mythimna separata, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudoplusia includens, Pyrausta nubilalis, Rachiplusia nu, Schoenobius spp., Scirpophaga spp., Scotia segetum, Sesamia spp., Sparganothis spp., Spodoptera spp., Stathmopoda spp., Stomopteryx subsecivella, Synanthedon spp., Tecia solanivora, Thermesia gemmatalis, Tinea pellionella, Tineola bisselliella, Tortrix spp., Trichophaga tapetzella, Trichoplusia spp., Tuta absoluta, Virachola spp.

From the order of the Orthoptera, for example, Acheta domesticus, Blatta orientalis, Blattella germanica, Dichroplus spp., Gryllotalpa spp., Leucophaea maderae, Locusta spp., Melanoplus spp., Periplaneta spp., Pulex irritans, Schistocerca gregaria, Supella longipalpa.

From the order of the Siphonaptera, for example, Ceratophyllus spp., Ctenocephalides spp., Tunga penetrans, Xenopsylla cheopis.

From the order of the Symphyla, for example, Scutigerella spp.

From the order of the Thysanoptera, for example, Anaphothrips obscurus, Baliothrips biformis, Drepanothris reuteri, Enneothrips flavens, Frankliniella spp., Heliothrips spp., Hercinothrips femoralis, Rhipiphorothrips cruentatus, Scirtothrips spp., Taeniothrips cardamoni, Thrips spp.

From the order of the Zygentoma (=Thysanura), for example, Lepisma saccharina, Thermobia domestica.

for example Lepisma saccharina, Thermobia domestica.

Pests from the phylum of: Mollusca, especially from the class of the Bivalvia, for example Dreissena spp.

From the class of the Gastropoda, for example, Anion spp., Biomphalaria spp., Bulinus spp., Deroceras spp., Galba spp., Lymnaea spp., Oncomelania spp., Pomacea spp., Succinea spp.

Animal parasites from the phyla of: Plathelminthes and Nematoda, especially from the class of the helminths, for example, Ancylostoma duodenale, Ancylostoma ceylanicum, Acylostoma braziliensis, Ancylostoma spp., Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

Plant pests from the phylum of: Nematoda, i.e. phytoparasitic nematodes, especially Aphelenchoides spp., Bursaphelenchus spp., Ditylenchus spp., Globodera spp., Heterodera spp., Longidorus spp., Meloidogyne spp., Pratylenchus spp., Radopholus similis, Trichodorus spp., Tylenchulus semipenetrans, Xiphinema spp.

Subphylum: Protozoa

It is also possible to control protozoa, such as Eimeria.

However, the compounds according to the invention can also be employed to protect the plant against biotic stress factors and/or abiotic stress, or to increase plant growth. The compounds according to the invention can also be employed for enhancing the defensive strength of the plants (defense against plant pathogens).

Furthermore, the compounds according to the invention can be employed in combination with other agrochemically active compounds, the latter including all known insecticides, fungicides, herbicides or safeners. Likewise, the compounds according to the invention can also be employed in combination with compositions or compounds of signalling technology, leading, for example, to better colonization by symbionts such as, for example rhizobia, mycorrhizae and/or endophytic bacteria, and/or to optimized nitrogen fixation.

In the present application, the terms “active compound” and “compound according to the invention” are used synonymously.

The treatment of the plants and plant parts with the compounds according to the invention is carried out directly or by action on their surroundings, habitat or storage space using customary treatment methods, for example by dipping, spraying, atomizing, irrigating, evaporating, dusting, fogging, broadcasting, foaming, painting, spreading-on, injecting, watering (drenching), drip irrigating and, in the case of propagation material, in particular in the case of seed, furthermore as a powder for dry seed treatment, a solution for seed treatment, a water-soluble powder for slurry treatment, by incrusting, by coating with one or more coats, etc. It is furthermore possible to apply the active compounds by the ultra-low volume method or to inject the active compound preparation or the active compound itself into the soil.

A preferred direct treatment of the plants is foliar application, i.e. at least one of the compounds according to the invention is applied to the foliage, where the treatment frequency and the application rate can be adapted to the level of infestation with the pest in question.

In the case of systemically active compounds, the compound according to the invention reaches the plants via the root system. In that case, the plants are treated by the action of the compound according to the invention on the habitat of the plant. This can take place, for example, by drenching, mixing into the soil oder mixing into the nutrient solution. For instance, the location of the plant (for example the soil or hydroponic systems) is drenched with a liquid form of the compound according to the invention, or the soil in which the plant grows is treated with a solid form of the compound according to the invention (for example in the form of granules) (for example introduction of the granules into the location of the plant). In the case of paddy rice crops, this can also be done by metering the invention in a solid application form (for example as granules) into a flooded paddy field.

All plants and plant parts can be treated in accordance with the invention. Plants are understood here to mean all plants and plant populations, such as wanted and unwanted wild plants or crop plants (including naturally occurring crop plants). Crop plants may be plants obtainable by conventional breeding and optimization methods or by biotechnological and gene-technological methods, or combinations of these methods, including the transgenic plants and including the plant cultivars protectable or not protectable by plant breeders' rights. Plant parts are understood to mean all parts and organs of plants above and below the ground, such as shoot, leaf, flower and root, examples of which include leaves, needles, stalks, stems, flowers, fruit bodies, fruits and seeds, and also roots, tubers and rhizomes. Parts of plants also include harvested plants and vegetative and generative propagation material, for example seedlings, tubers, rhizomes, cuttings and seeds.

In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above. More preferably, plants of the plant cultivars which are commercially available or are in use are treated in accordance with the invention. Plant cultivars are understood to mean plants having new properties (“traits”) and which have been obtained by conventional breeding, by mutagenesis or by recombinant DNA techniques. They can be cultivars, varieties, bio- or genotypes.

Of course, it is also possible to treat, with the compound according to the invention, seed of a plant that has been modified in a conventional manner or genetically, or genetically modified seed, by employing suitable methods using suitable seed-dressing formulations.

Formulations which are suitable according to the invention, and use forms prepared therefrom, as crop protection agents and/or pesticides are, for example, drench, drip and spray liquors comprising at least one of the compounds according to the invention. In some cases, the use forms comprise further crop protection agents and/or pesticides and/or adjuvants which improve action, such as penetrants, e.g. vegetable oils, for example rapeseed oil, sunflower oil, mineral oils, for example paraffin oils, alkyl esters of vegetable fatty acids, for example rapeseed oil methyl ester or soya oil methyl ester, or alkanol alkoxylates, and/or spreaders, for example alkylsiloxanes, and/or salts, for example organic or inorganic ammonium or phosphonium salts, for example ammonium sulfate or diammonium hydrogenphosphate, and/or retention promoters, for example dioctyl sulfosuccinate or hydroxypropyl guar polymers, and/or humectants, for example glycerol, and/or fertilizers, for example ammonium-, potassium- or phosphorus-containing fertilizers.

Customary formulations are, for example, water-soluble liquids (SL), emulsion concentrates (EC), emulsions in water (EW), suspension concentrates (SC, SE, FS, OD), water-dispersible granules (WG), granules (GR) and capsule concentrates (CS); these and further possible formulation types are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576. The formulations optionally comprise, in addition to one or more active compounds according to the invention, further agrochemically active compounds.

These are preferably formulations or use forms which comprise auxiliaries, for example extenders, solvents, spontaneity promoters, carriers, emulsifiers, dispersants, antifreezes, biocides, thickeners and/or further auxiliaries, for example adjuvants. An adjuvant in this context is a component which enhances the biological effect of the formulation, without the component itself having a biological effect. Examples of adjuvants are agents which promote retention, spreading, attachment to the leaf surface or penetration.

These formulations are prepared in a known manner, for example by mixing the active compounds with auxiliaries such as, for example, extenders, solvents and/or solid carriers and/or further auxiliaries such as, for example, surfactants. The formulations are produced either in suitable production plants or else before or during application.

Auxiliaries used may be substances capable of giving the formulation of the active compound, or the application forms prepared from these formulations (such as ready-to-use crop protection agents, for example, such as spray liquors or seed dressings) particular properties, such as certain physical, technical and/or biological properties.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulfones and sulfoxides (such as dimethyl sulfoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulfoxide, and also water.

In principle it is possible to use all suitable solvents. Examples of suitable solvents are aromatic hydrocarbons, such as xylene, toluene or alkylnaphthalenes, chlorinated aromatic or chlorinated aliphatic hydrocarbons, such as chlorobenzene, chloroethylene or methylene chloride, aliphatic hydrocarbons, such as cyclohexane, paraffins, petroleum fractions, mineral and vegetable oils, alcohols, such as methanol, ethanol, isopropanol, butanol or glycol and their ethers and esters, ketones such as acetone, methyl ethyl ketone, methyl isobutyl ketone or cyclohexanone, strongly polar solvents, such as dimethyl sulfoxide, and also water.

In principle it is possible to use all suitable carriers. Useful carriers include in particular: for example ammonium salts and ground natural minerals such as kaolins, clays, talc, chalk, quartz, attapulgite, montmorillonite or diatomaceous earth, and ground synthetic materials such as finely divided silica, alumina and natural or synthetic silicates, resins, waxes and/or solid fertilizers. Mixtures of such carriers may also be used. Useful carriers for granules include: for example crushed and fractionated natural rocks such as calcite, marble, pumice, sepiolite, dolomite, and synthetic granules of inorganic and organic meals, and also granules of organic material such as sawdust, paper, coconut shells, maize cobs and tobacco stalks.

Liquefied gaseous extenders or solvents can also be used. Particularly suitable extenders or carriers are those which are gaseous at ambient temperature and under atmospheric pressure, for example aerosol propellant gases, such as halogenated hydrocarbons, and also butane, propane, nitrogen and carbon dioxide.

Examples of emulsifiers and/or foam formers, dispersants or wetting agents with ionic or nonionic properties, or mixtures of these surfactants, are salts of polyacrylic acid, salts of lignosulfonic acid, salts of phenolsulfonic acid or naphthalenesulfonic acid, polycondensates of ethylene oxide with fatty alcohols or with fatty acids or with fatty amines, with substituted phenols (preferably alkylphenols or arylphenols), salts of sulfosuccinic esters, taurine derivatives (preferably alkyl taurates), phosphoric esters of polyethoxylated alcohols or phenols, fatty acid esters of polyols, and derivatives of the compounds containing sulfates, sulfonates and phosphates, for example alkylaryl polyglycol ethers, alkyl sulfonates, alkylsulfates, arylsulfonates, protein hydrolysates, lignosulfite waste liquors and methylcellulose. The presence of a surfactant is advantageous if one of the active compounds and/or one of the inert carriers is insoluble in water and when the application takes place in water.

It is possible to use colorants such as inorganic pigments, for example iron oxide, titanium oxide and Prussian Blue, and organic dyes such as alizarin dyes, azo dyes and metal phthalocyanine dyes, and nutrients and trace nutrients such as salts of iron, manganese, boron, copper, cobalt, molybdenum and zinc as further auxiliaries in the formulations and the use forms derived therefrom.

Stabilizers, such as low-temperature stabilizers, preservatives, antioxidants, light stabilizers or other agents which improve chemical and/or physical stability, may also be present. Foam formers or antifoams may also be present.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids may also be present as additional auxiliaries in the formulations and the use forms derived therefrom. Other possible auxiliaries are mineral and vegetable oils.

If appropriate, the formulations and the use forms derived therefrom may also comprise further auxiliaries. Examples of such additives include fragrances, protective colloids, binders, adhesives, thickeners, thixotropic agents, penetrants, retention promoters, stabilizers, sequestrants, complexing agents, humectants, spreaders. In general, the active compounds can be combined with any solid or liquid additive customarily used for formulation purposes.

Useful retention promoters include all those substances which reduce the dynamic surface tension, for example dioctyl sulfosuccinate, or increase the viscoelasticity, for example hydroxypropylguar polymers.

Useful penetrants in the present context are all those substances which are typically used to improve the penetration of active agrochemical compounds into plants. Penetrants are defined in this context as being able to penetrate the cuticle of the plant, from the (in general aqueous) application mixture and/or from the spray covering, and being able thereby to raise the mobility of the active compounds in the cuticle. The method described in the literature (Baur et al., 1997, Pesticide Science 51, 131-152) can be used for determining this property. Examples include alcohol alkoxylates such as coconut fatty ethoxylate (10) or isotridecyl ethoxylate (12), fatty acid esters, for example rapeseed oil methyl ester or soya oil methyl ester, fatty amine alkoxylates, for example tallowamine ethoxylate (15), or ammonium and/or phosphonium salts, for example ammonium sulfate or diammonium hydrogenphosphate.

The formulations preferably comprise between 0.00000001% and 98% by weight of active compound or, with particular preference, between 0.01% and 95% by weight of active compound, more preferably between 0.5% and 90% by weight of active compound, based on the weight of the formulation.

The active compound content of the use forms (crop protection agents) prepared from the formulations can vary within wide limits. The active compound concentration of the use forms may typically be between 0.00000001% and 95% by weight of active compound, preferably between 0.00001% and 1% by weight, based on the weight of the use form. The compounds are applied in a customary manner appropriate for the use forms.

The reaction according to the invention is illustrated in Reaction Scheme 2 below, without limiting the invention to this example.

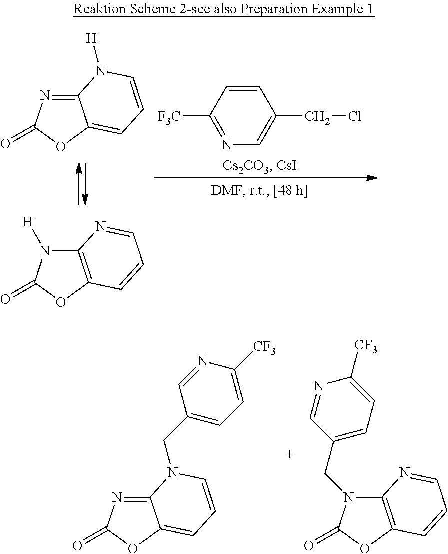

The compound of the formula (II) used, here the compound (IIb), is oxazolo[4,5-b]pyridin-2(3H)-one, and the compound of the formula (III) used is 5-chloromethyl-2-trifluoromethylpyridine. Reaction of the compounds mentioned above in the presence of a base, here DMF, and suitable alkali metal salts, here Cs₂CO₃ and CsI, gives a mixture of the compound of the formula (I-g) according to the invention, that is 4-(6-trifluoromethylpyridin-3-ylmethylloxazolo[4,5-b]pyridin-2(4H)-one, and the compound of the formula (IV), that is 3-(6-trifluoromethylpyridin-3-ylmethyl)oxazolo[4,5-b]-2(3H)-one.

A variant of the reaction according to the invention is illustrated in Reaction Scheme 3 below, without limiting the invention to this example.

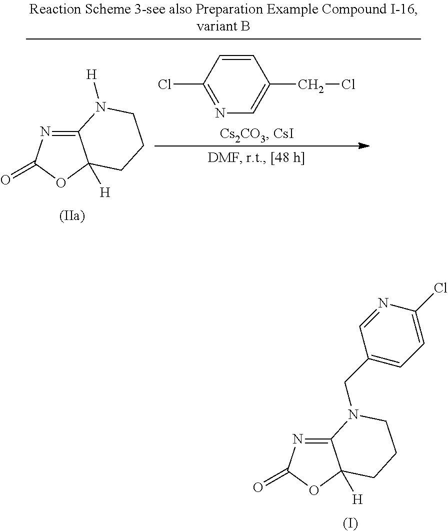

The compound of the formula (II) used, here the compound (IIa), is 5,6,7,7α-tetrahydrooxazolo[4,5-b]-pyridin-2(4H)-one, and the compound of the formula (III) used is 2-chloro-5-chloromethylpyridine. Reaction of the compounds mentioned above in the presence of a diluent, here DMF, and a suitable basic reaction auxiliary, here Cs₂CO₃ and CsI, gives the compound of the formula (I-m), that is 4-(6-chloropyridin-3-ylmethyl)-5,6,7,7a-tetrahydrooxazolo[4,5-b]-pyridin-2(4H)-one.

Some of the compounds of the formula (II) are commercially available or can be obtained by methods known from the literature.

(A) If compounds of the general formula (II) in which B represents oxygen, sulfur or N-alkylamino and Q represents oxygen or sulfur are to be prepared, it is preferred to use 3-substituted 2-nitropyridines (A-1) as starting components. Following their reduction with formation of the 3-substituted 2-aminopyridines (A-2) and subsequent ring closure reaction with compounds of the formula (A-3; Q=O, S and LG=Hal), it is possible to obtain the desired compounds of the formula (II).

Compounds of the general formula (II) in which Q represents sulfur can be converted oxidatively into compounds of the general formula (II) in which Q represents oxygen (cf., for example, oxidation with potassium permanganate: M. Marek et al., J. Photochem. Photobiol. A: Chemistry 192, 188-196, 2007).

Also known are modifications at the pyridine skeleton, for example the nitration (Y═NO₂, cf. IIb-1) and the subsequent reduction (Y═NH₂, cf. IIb-2; WO 2007/100758 A2), or the halogenation (cf. IIb-3; Y═Br, WO 2006/021886 A1; Y═Cl; WO 2006/031971 A1) (cf. Reaction Scheme 4).

In the reaction scheme below, the term (IIa-a) or (IIb-a) refers to compounds of the formula (IIa) or (IIb) that can be used to prepare the compounds of the formula (I-a) according to the invention.

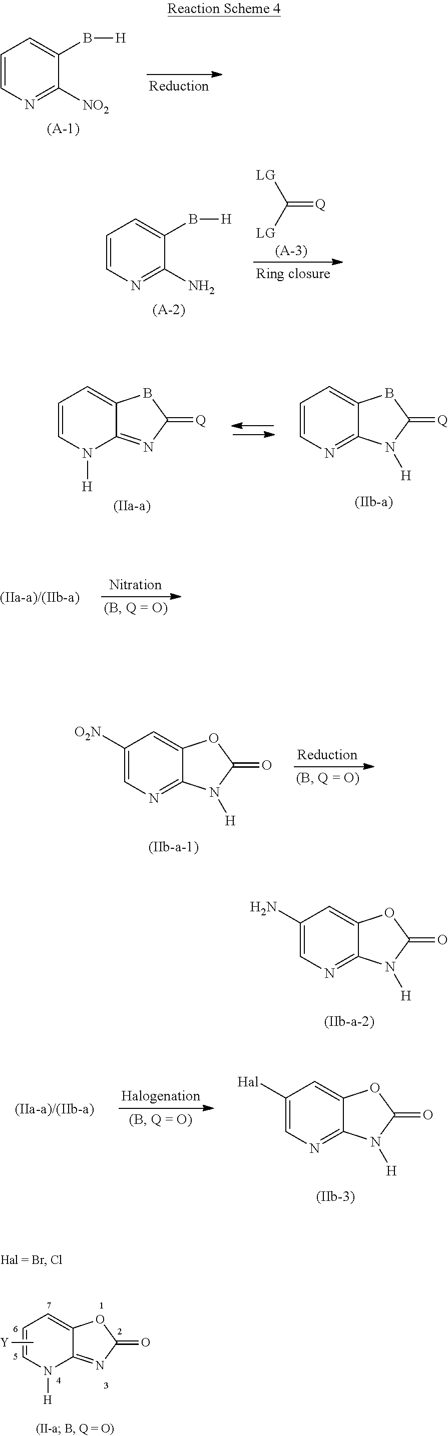

(B) If compounds of the general formula (II) in which B represents oxygen or N-alkylamino and Q represents oxygen or sulfur are to be prepared, it is preferred to use 3-substituted 2-nitropyridines (A-1) as starting components. Following the reduction of the nitro group (Y═NO₂), the pyridine system of the 3-substituted 2-aminopyridines (A-2) is hydrogenated under pressure (in particular from 4 to 10 bar) to give compounds of the formula (A-4, B═O; cf. also the acetate of the 2-amino-3,4,5,6-tetrahydropyridin-2-ol, WO 95/11231 A1). By subsequent ring closure reaction of the compounds (A-4) with compounds of the formula (A-3; Q=O, S and LG=Hal), it is possible to obtain the desired compounds of the formula (II) (cf. Reaction Scheme 5; synthesis of the starting materials).

In the reaction scheme below, the term (IIa-e) refers to compounds of the formula (IIa) that can be used to prepare the compounds of the formula (I-e).

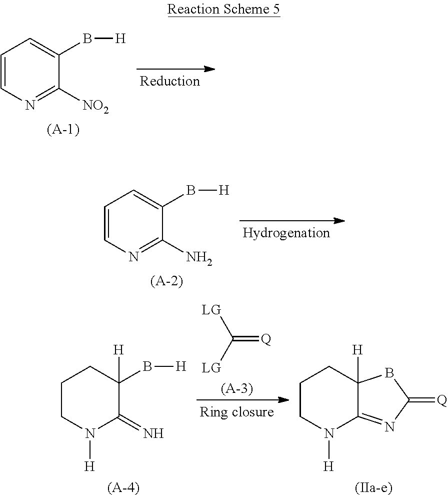

Known compounds of the general formula (II) are, for example:

(a) oxazolo[4,5-b]pyridin-2(3H)-ones of the formula (II) in which B and Q represent oxygen: oxazolo[4,5-b]pyridin-2(3H)-one (Y═H; WO 2010/135014 A1), 5-methyloxazolo[4,5-b]pyridin-2(3H)-one (Y=5-CH₃; DE 2439661 A1), 6-nitrooxazolo[4,5-b]pyridin-2(3H)-one (Y=6-NO₂; DE 2131734 A), 6-chlorooxazolo[4,5-b]pyridin-2(3H)-one (Y=6-Cl; DE 2131734 A), 6-bromooxazolo[4,5-b]pyridin-2(3H)-one (Y=6-Br; DE 2131734 A), 6-acetyloxazolo[4,5-b]pyridin-2(3H)-one (Y=6-COCH₃; EP 691339 A1), 6-aminooxazolo[4,5-b]pyridin-2(3H)-one (Y=6-NH₂; WO 2007/100758 A2);

(b) oxazolo[4,5-b]pyridine-2(3H)-thiones of the formula (II) in which B represents oxygen, Q represents sulfur: oxazolo[4,5-b]pyridine-2(3H)-thione (Y═H; JP 2003/238832 A), 5-methyloxazolo[4,5-b]pyridine-2(3H)-thione (Y=5-CH₃; WO 2007/146066 A2), 6-methyloxazolo[4,5-b]pyridine-2(3H)-thione (Y=6-CH₃; WO 2007/146066 A2), 6-bromooxazolo[4,5-b]pyridine-2(3H)-thione (Y=6-Br; JP 2003/238832 A);

(c) thiazolo[4,5-b]pyridin-2(3H)-ones of the formula (II) in which B represents sulfur, Q represents oxygen: thiazolo[4,5-b]pyridin-2(3H)-one (Y═H; F. Viviani et al., Bull. Soc. Chim. France, 130, 395-404, 1993);

(d) thiazolo[4,5-b]pyridine-2(3H)-thiones of the formula (II) in which B and Q represent sulfur: thiazolo[4,5-b]pyridine-2(3H)-thione (Y═H; WO 2010/071819 A1); 6-methylthiazolo[4,5-b]pyridine-2(3H)-thione (Y=6-CH₃; JP 2003/238832 A); 6-chlorothiazolo[4,5-b]pyridine-2(3H)-thione (Y=6-Cl; WO 2010/071819 A1);

(e) 1,3-dihydro-1-methyl-2H-imidazo[4,5-b]pyridine-2-thiones of the formula (II) in which B represents N-methyl and Q represents sulfur: 1,3-dihydro-1-methyl-2H-imidazo[4,5-b]pyridine-2-thione (Y═H; WO 2009/139340 A1);

(f) 1,3-dihydro-1-methyl-2H-imidazo[4,5-b]pyridin-2-ones of the formula (II) in which B represents N-methyl and Q represents oxygen: 1,3-dihydro-1-methyl-2H-imidazo[4,5-b]pyridin-2-one (Y═H; F. Savelli et al., J. Het. Chem. 24, 1709-1716, 1987); 5-chloro-1,3-dihydro-1-methyl-2H-imidazo[4,5-b]pyridin-2-one (Y=5-Cl; DE 2241575 A1); 1,3-dihydro-1,6-dimethyl-2H-imidazo[4,5-b]pyridin-2-one (Y=6-CH₃; S. Lindstroem et al., Heterocycles 38, 529-540, 1994), 1,3-dihydro-1,7-dimethyl-2H-imidazo[4,5-b]pyridin-2-one (Y=7-CH₃; S. Lindstroem et al., Heterocycles 38, 529-540, 1994); and

(g) 1,3-dihydro-2H-pyrrolo[2,3-b]pyridin-2-ones of the formula (II) in which B represents methylene (CH₂) and Q represents oxygen: 1,3-dihydro-2H-pyrrolo[2,3-b]pyridin-2-one (Y═H; U.S. Pat. No. 5,023,265); 5-bromo-1,3-dihydro-2H-pyrrolo[2,3-b]pyridin-2-one (Y=5-Br; US 2010/0204214 A1); 7-fluoro-1,3-dihydro-2H-pyrrolo[2,3-b]pyridin-2-one (Y=7-F; WO 2008/075109 A1) or 7-chloro-1,3-dihydro-2H-pyrrolo[2,3-b]pyridin-2-one (Y=7-Cl; WO 2001/046196 A1).

Some of the compounds of the formula (III) are commercially available or can be obtained by methods known from the literature. General routes for preparing the compounds of the formula (III) are shown in Reaction Scheme 6.

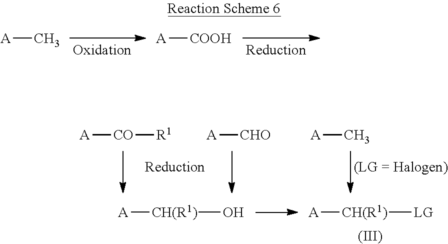

Some of the compounds of the formula (III) in which R¹ represents hydrogen are commercially available, some are known, or they can be obtained by known methods.

Known compounds of the formula (III) are, for example: 2-chloro-5-chloromethyl-1,3-thiazole (WO 98/32747 A1, EP 780384 A2), 2-bromo-5-bromomethyl-1,3-thiazole (EP 376279 A2), 5-bromomethyl-2-methyl-1,3-thiadiazole (WO 2010/132999 A1); 5-bromomethyl-2-trichloromethyl-1,3-thiazole (U.S. Pat. No. 5,338,856 A2), 5-bromomethyl-3-methylisoxazole (DE 2045050 A), (R,S)-3-(bromomethyl)tetrahydrofuran (WO 2008/101867 A1), (R,S)-3-(bromomethyl)tetrahydrothiophene (E. W. Della, S. D. Graney J. Org. Chem. 2004, 69, 3824-3835), 6-chloro-3-chloromethylpyridine (DE 3 630 046 A1, EP 373 464 A2, EP 393 453 A2 or EP 569 947 A1), 6-bromo-3-chloromethylpyridine (U.S. Pat. No. 5,420,270 A), 6-fluoro-3-chloromethylpyridine (WO 2010/042642 A1); 2-methyl-3-chloromethylpyridine (EP 302 389 A2), 2-trifluoromethyl-3-chloromethylpyridine (WO 2004/082616 A2), 3-chloro-6-chloromethylpyridazine (EP 284 174 A1) and 2-chloro-5-pyrazinylmethyl bromide (JP 05 239 034 A).

Methyl-substituted heterocycles (A-CH₃) can be converted, for example by oxidation, into corresponding heterocyclic carboxylic acids (A-COOH): cf., for example, 3-thiophenecarboxylic acid (JP 03056478 A), 5-fluoro-6-bromonicotinic acid (F. L. Setliff, G. O. Rankin, J. Chem. Eng. Data 1972, 17, 515-516), 5-chloro-6-bromonicotinic acid and 5-iodo-6-bromonicotinic acid (F. L. Setliff et al., J. Chem. Eng. Data 1978, 23, 96-97), 5,6-dibromonicotinic acid (F. L. Setliff et al., J. Chem. Eng. Data 1970, 15, 590-591), 5-fluoro-6-iodonicotinic acid and 5-bromo-6-iodonicotinic acid (F. L. Setliff et al., J. Chem. Eng. Data 1973, 18, 449-450), 5-chloro-6-iodonicotinic acid (F. L. Setliff, J. E. Lane J. Chem. Eng. Data 1976, 21, 246-247) or carboxylic esters, for example methyl 5-methyl-6-fluoronicotinate (WO 98/33772 A1) and methyl 5-methyl-6-bromonicotinate (WO 97/30032 A1).

Known is furthermore the synthesis of formyl group-containing heterocycles (A-CHO, for example 6-chloro-3-formyl-5-methylpyridine: DE 4429465 A1) from non-cyclic starting components; this can be effected, for example, by 1,3-dipolar cycloaddition (e.g.: 5-chloromethyl-3-bromoisoxazole: P. Pevarello, M. Varasi Synth. Commun. 1992, 22, 1939-1948).

The heterocyclic carboxylic acids (A-COOH), carboxylic esters (A-COOR, R=alkyl), formyl-substituted heterocycles (A-CHO) or alkylcarbonyl compounds (A-CO—R¹; R¹=alkyl) can then be converted by methods known from the literature into the corresponding heterocyclic hydroxyalkyl compounds (A-CH(R¹)—OH; R¹═H, alkyl), cf., for example: (3R)-tetrahydro-3-furanmethanol (WO 2009/135788 A1), 1,2,5-thiadiazole-3-methanol (WO 2008/063867 A2), (αR)-α,2,4-trimethyl-5-oxazolemethanol (WO 2008/134036 A1) or α,4-dimethyl-5-thiazolemethanol (FR 2555583 A1), (2-chloro-1,3-thiazol-5-yl)methanol (WO 2007/002181 A2), (2-bromo-1,3-thiazol-5-yl)methanol (WO 2008/057336 A2, WO 2009/077990 A1, WO 2009/077954 A1), 1,3-oxazol-2-ylmethanol (WO 2009/077954 A1) or tetrahydro-3-furanmethanol (U.S. Pat. No. 5,912,364 A).

The hydroxyalkyl compounds (A-CH(R¹)—OH; R¹═H, alkyl) can then be converted by known methods into activated heterocyclic hydroxymethyl compounds (A-CH(R¹)-LG, LG=O-tosyl, O-mesyl) or heterocyclic halomethyl compounds (A-CH(R¹)-LG, LG=Hal). (cf., for example, 2-chloro-5-(chloromethyl)-1,3-thiazole (WO 2008/073936 A1), 2-bromo-5-bromomethyl-1,3-thiazole (US 2006/0293364 A1) or tetrahydro-3-furanmethanol-3-(4-methylbenzenesulfonate (US 2010/0093814 A1).

The latter can also be obtained from corresponding methyl group-containing heterocycles (A-CH₃) using suitable halogenting agents known from the literature. Examples for this procedure which may be mentioned are the syntheses of the halomethyl-substituted heterocycles, for example 2-chloro-5-(chloromethyl)-1,3-thiazole (WO 97/23469 A1) or 5-bromomethyl-2-chloro-1,3-thiazole (WO 2005/082859 A1), 5-chloromethyl-2-methylpyrimidine (U. Eiermann et al., Chem. Ber. 1990, 123, 1885-9), 3-chloromethyl-5-bromo-6-chloropyridine or 3-bromo-5-iodo-6-chloropyridine (S. Kagabu et al., J. Pestic. Sci. 2005, 30, 409-413).

Starting materials (A-10) in which A represents a 5,6-disubstituted 3-pyridinyl radical can also be obtained by known methods. Suitable and known starting materials are, for example, 6-halogen-substituted 5-nitro-β-picolines (A-5) which may be modified according to known literature procedures (cf. Reaction Scheme 7).

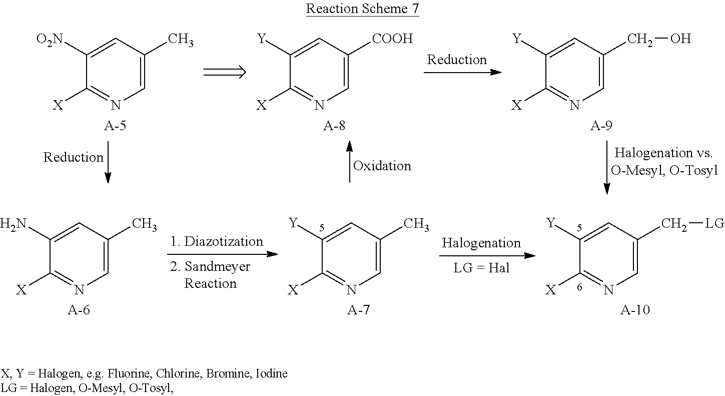

The reduction of the nitro group in 6-halo-substituted 5-nitro-β-picolines (A-5), for example, leads to 6-halo-substituted 5-amino-β-picolines (A-6): cf. 5-amino-6-chloro-(3-picoline and 5-amino-6-bromo-β-picoline (Setliff, F. L. Org. Preparations and Preparations Int. 1971, 3, 217-222; Kagabu, S. et al. J. Pestic. Sci. 2005, 30, 409-413). Subsequent diazotization and Sandmeyer reaction (C. F. H. Allen, J. R. Thirtle, Org. Synth., Coll. Vol. III, 1955, p. 136) allow the introduction of halogen-substituents into the 5-position (A-7): cf. 5-fluoro-6-chloro-(3-picoline and 5-fluoro-6-bromo-β-picoline (Setliff, F. L. Org. Preparations and Preparations Int. 1971, 3, 217-222), 5-iodo-6-chloro-β-picoline (Kagabu, S. et al. J. Pestic. Sci. 2005, 30, 409-413), 5,6-dichloropicoline (Setliff, F. L.; Lane, J. E. J. Chem. Engineering Data 1976, 21, 246-247).

As is known, the oxidation of the methyl group in the 5,6-disubstituted β-picolines (A-7) can then lead to the corresponding 5,6-disubstituted nicotinic acids (A-8): cf. 5-fluoro-6-chloronicotinic acid and 5-fluoro-6-bromonicotinic acid (Setliff F. L., Rankin G. O. J. Chem. Engineering Data 1972, 17, 515-516), 5-bromo-6-fluoronicotinic acid (WO 2009/010488 A1), 5-bromo-6-chloronicotinic acid and 5-bromo-6-bromonicotinic acid (F. L. Setliff J. Chem. Engineering Data 1970, 15, 590-591), 5-chloro-6-bromonicotinic acid and 5-iodo-6-bromonicotinic acid (Setliff, F. L., Greene, J. S. J. Chem. Engineering Data 1978, 23, 96-97). Also known is 5-chloro-6-trifluoromethylnicotinic acid (F. Cottet et al., Synthesis 2004, 10, 1619-1624) which, in the presence of reducing agents, can be converted into the corresponding 3-hydroxymethylated pyridines (A-9): cf. 5-bromo-6-chloro-3-hydroxymethylpyridine (Kagabu, S. et al., J. Pestic. Sci. 2005, 30, 409-413).

Using 6-chloro-5-nitronicotinic acid (A-8, X═Cl, Y═NO₂; Boyer, J. H.; Schoen, W., J. Am. Chem. Soc. 1956, 78, 423-425) it is possible, for example by reduction, to form 6-chloro-3-hydroxymethyl-5-nitropyridine (A-9, X═Cl, Y═NO₂; Kagabu, S. et al., J. Med. Chem. 2000, 43, 5003-5009), which is then reduced to 6-chloro-3-hydroxymethyl-5-aminopyridine (A-9, X═Cl, Y═NH₂; Kagabu, S. et al., J. Med. Chem. 2000, 43, 5003-5009) and, by diazotization and reaction with hydroxylamine, converted into 6-chloro-3-hydroxymethyl-5-azidopyridine (A-9, X═Cl, Y═N₃; Kagabu, S. et al., J. Med. Chem. 2000, 43, 5003-5009). Subsequent halogenation with thionyl chloride then affords 6-chloro-3-chloromethyl-5-azidopyridine (VII, X═Cl, Y═N₃, LG=Cl; Kagabu, S. et al., J. Med. Chem. 2000, 43, 5003-5009).

Alternatively, the halogenation of the methyl group in the 3-position of (A-7) may lead to the compounds (A-10) in which LG represents halogen: cf. 3-bromomethyl-6-chloro-5-fluoropyridine or 3-bromomethyl-6-chloro-5-iodopyridine (Kagabu, S. et al. J. Pestic. Sci. 2005, 30, 409-413). If 6-halo-substituted 5-nitro-β-picolines (A-7; Y═NO₂) are used, the methyl group in the 3-position may be halogenated first: cf. 3-bromomethyl-6-chloro-5-nitropyridine (Kagabu, S. et al., J. Pestic. Sci. 2005, 30, 409-413). If appropriate, the nitro group may also be reduced at a later stage in the reaction sequence.

Also known in the literature is the introduction of a in 5-position (for example Y═N₃) in the case of compounds (A-10) in which LG represents N-morpholino. It is then very simple to replace this radical by halogen (LG=Hal) (cf. S. Kagabu et al., J. Med. Chem. 2000, 43, 5003-5009; reaction conditions: ethyl chloroformate, tetrahydrofuran, 60° C.).

In general, halogen atoms in the vicinity of the pyridine nitrogen can be replaced by other halogen atoms or halogenated groups such as, for example, trifluoromethyl (transhalogenation, for example: chlorine for bromine or iodine; bromine for iodine or fluorine; iodine for fluorine or a trifluoromethyl group). Accordingly, a further alternative synthesis route consists in replacing the halogen atom (for example X═Cl) in the 6-position of the nicotinic acid (A-8). It is known, for example, to replace a chlorine atom in: 5,6-dichloronicotinic acid by iodine with formation of 5-chloro-6-iodonicotinic acid (X═I, Y═Cl: in the presence of sodium iodide; Setliff, F. L.; Lane, J. E. J. Chem. Engineering Data 1976, 21, 246-247), 6-chloro-5-fluoronicotinic acid by iodine with formation of 5-fluoro-6-iodonicotinic acid (X═I, Y═F: in the presence of sodium iodide; Setliff, F. L.; Price, D. W. J. Chem. Engineering Data 1973, 18, 449-450) or 6-chloro-5-bromonicotinic acid by iodine with formation of 5-bromo-6-iodonicotinic acid (X═I, Y═Br: in the presence of sodium iodide; Setliff, F. L.; Price, D. W. J. Chem. Engineering Data 1973, 18, 449-450). However, this transhalogenation may also be left for suitable compounds of the general formula (I).

The present invention is illustrated by the examples below; however, the invention is not limited by these examples.

### A: PREPARATION EXAMPLES

### Example I-1

### 4-(6-Trifluoromethylpyridin-3-ylmethyl)oxazolo[4,5-b]pyridin-2(4H)-one

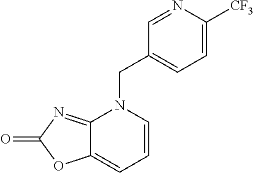 [SMILES: O=c1nc2n(Cc3ccc(C(F)(F)F)nc3)cccc-2o1]

125 mg of cesium iodide were added to a stirred solution of 1.00 g (7.34 mmol) of oxazolo[4,5-b]pyridin-2(3H)-one (cf. WO 2010/135014 A1), 1.43 g (7.34 mmol) of 5-chloromethyl-2-trifluoromethylpyridine (cf. WO 2004/082616 A2), 3.59 g (11.02 mmol) of cesium carbonate in 100 ml of N,N-dimethylformamide (DMF). The entire reaction mixture was then stirred at room temperature for about 48 hours. The reaction mixture was then filtered and concentrated under reduced pressure, and the residue that remained was purified chromatographically by preparative HPLC (RP phase; water/acetonitrile gradient). This gives 547.7 mg (25.1% of theory) of 4-(6-trifluoromethylpyridin-3-ylmethyl)oxazolo[4,5-b]pyridin-2(4H)-one.

LC-MS (ESI positive): m/z found: 296.1.

[M⁺+H]. C₁₃H₈F₃N₃O₂ calculated: 295.2.

¹H NMR (600 MHz, DMSO-d₆) δ 5.66 (s, 2H), 6.96 (t, 1H), 7.48 (dd, 1H), 7.94 (d, 1H), 7.99 (d, 1H), 8.0 (d, 1H), 8.10 (dd, 1H), 8.88 (d, 1H) ppm

¹³C with ¹H decoupling (CPD) NMR (150 MHz, DMSO-d₆) δ 52.4 (CH₂), 112.8, 112.9, 131.0, 144.1, 159.4 (Hetaryl-C), 121.7 (Py-CF₃), 121.1, 134.9, 138.4, 146.1, 150.3 (Py-C), 162.4 (C═O) ppm

As a further product (compound IV-1), 720.5 mg (33.2% of theory) of 3-(6-trifluoromethylpyridin-3-ylmethyl)oxazolo[4,5-b]-2(3H)-one were isolated.

### Example I-2

### 4-(5,6-Dichloropyridin-3-ylmethyl)oxazolo[4,5-b]pyridin-2(4H)-one

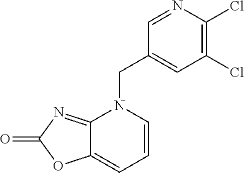 [SMILES: O=c1nc2n(Cc3cnc(Cl)c(Cl)c3)cccc-2o1]

The synthesis was carried out analogously to the reaction procedure of Example I-1 using: 1.00 g (7.34 mmol) of oxazolo[4,5-b]pyridin-2(3H)-one (cf. WO 2010/135014 A1), 1.43 g (7.34 mmol) of 5-chloromethyl-2,3-dichloropyridine (cf. DE 2405930 A1), 3.59 g (11.02 mmol) of cesium carbonate in 100 ml of DMF, 125 mg of cesium iodide.

This gives 265.6 mg (11.2% of theory) of 4-(5,6-dichloropyridin-3-ylmethyl)oxazolo[4,5-b]pyridin-2(4H)-one.

LC-MS (ESI positive): m/z found: 296.0 [M⁺].

C₁₂H₇Cl₂N₃O₂ calculated: 296.1.

¹H NMR (600 MHz, DMSO-d₆) δ 5.54 (s, 2H), 6.93 (t, 1H), 7.45 (dd, 1H), 7.94 (d, 1H), 8.25 (d, 1H), 8.52 (d, 1H) ppm

¹³C with ¹H decoupling (CPD) NMR (150 MHz, DMSO-d₆) δ 51.5 (CH₂), 112.7, 112.9, 130.8, 144.1, 159.4 (hetaryl-C), 129.4, 147.8 (Py-CCl), 132.1, 139.9, 148.3 (Py-C), 162.4 (C═O) ppm

As a further product (compound IV-2), 836.9 mg (37.7% of theory) of 3-(5,6-dichloropyridin-3-ylmethyl)oxazolo[4,5-b]-2(3H)-one were isolated.

### Example I-3

### 4-(6-Chloropyridin-3-ylmethyl)oxazolo[4,5-b]pyridin-2(4H)-one

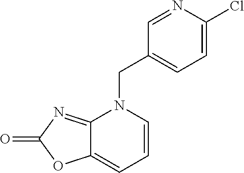 [SMILES: O=c1nc2n(Cc3ccc(Cl)nc3)cccc-2o1]

The synthesis was carried out analogously to the reaction procedure of Example I-1 using:

0.50 g (3.67 mmol) of oxazolo[4,5-b]pyridin-2(3H)-one (cf. WO 2010/135014 A1), 0.59 g (3.67 mmol) of 2-chloromethyl-5-chloromethylpyridine, 1.79 g (5.51 mmol) of cesium carbonate in 50 ml of DMF, 62.5 mg of cesium iodide.

This gives 276.8 mg (28.8% of theory) of 4-(6-chloropyridin-3-ylmethylloxazolo[4,5-b]pyridin-2(4H)-one.

LC-MS (ESI positive): m/z found: 262.0 [M⁺+H].

C₁₂H₈ClN₃O₂ calculated: 261.6.

¹H NMR (600 MHz, CD₃CN) δ 5.53 (s, 2H), 6.79 (t, 1H), 7.21 (dd, 1H), 7.40 (dd, 1H), 7.53 (dd, 1H), 7.81 (dd, 1H), 8.47 (m, 1H) ppm

¹³C with ¹H decoupling (CPD) NMR (150 MHz, CD₃CN) δ 53.2 (CH₂), 112.7, 113.4, 130.6, 145.7, 161.1 (hetaryl-C), 152.1 (Py-CCl), 125.4, 130.9, 140.6, 150.8 (Py-C), 163.8 (C═O) ppm

As a further product (compound IV-3), 159.4 mg (16.5% of theory) of 3-(6-chloropyridin-3-ylmethylloxazolo[4,5-b]-2(3H)-one were isolated.

LC-MS (ESI positive): m/z found: 262.0 [M⁺+H].

C₁₂H₈ClN₃O₂ calculated: 261.6.

¹³C with ¹H decoupling (CPD) NMR (150 MHz, CD₃CN) δ 42.2 (CH₂), 117.2, 119.6, 138.1, 143.9 (hetaryl-C), 151.2 (Py-CCl), 125.1, 131.7, 140.4, 150.7 (Py-C), 154.2 (C═O) ppm

### Example I-4

### 4-(6-Chloro-5-fluoropyridin-3-ylmethyl)oxazolo[4,5-b]pyridin-2(4H)-one

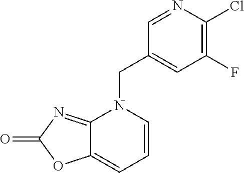 [SMILES: O=c1nc2n(Cc3cnc(Cl)c(F)c3)cccc-2o1]

The synthesis was carried out analogously to the reaction procedure of Example I-1 using: 0.50 g (3.67 mmol) of oxazolo[4,5-b]pyridin-2(3H)-one (cf. WO 2010/135014 A1), 0.82 g (3.67 mmol) of 2-chloro-5-chloromethyl-3-fluoropyridine (DE 102006015468 A1), 1.79 g (5.51 mmol) of cesium carbonate in 50 ml of DMF, 62.5 mg of cesium iodide.

This gives 32.0 mg (3.1% of theory) of 4-(6-chloro-5-fluoropyridin-3-ylmethylloxazolo[4,5-b]pyridin-2(4H)-one.

LC-MS (ESI positive): m/z found: 280.0 [M⁺+H].

C₁₂H₇ClFN₃O₂ calculated: 279.0.

¹H NMR (600 MHz, DMF-d₆) δ 5.73 (s, 2H), 6.99 (t, 1H), 7.47 (dd, 1H), 8.08 (dd, 1H), 8.16 (dd, 1H), 7.56 (d, 1H) ppm

¹³C with ¹H decoupling (CPD) NMR (150 MHz, DMF-d₆) δ 52.4 (CH₂), 112.6, 113.3, 145.2, 160.7 (hetaryl-C), 138.5 (Py-CCl), 154.9 (Py-CF), 126.4, 133.3, 146.2 (Py-C), 163.1 (C═O) ppm

### Example I-5

### 4-(5-Methylpyrazin-2-ylmethyl)oxazolo[4,5-b]pyridin-2(4H)-one

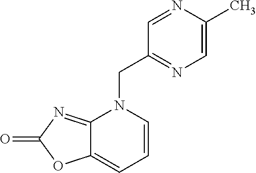 [SMILES: Cc1cnc(Cn2cccc3oc(=O)nc2-3)cn1]

The synthesis was carried out analogously to the reaction procedure of Example I-1 using:

0.50 g (3.67 mmol) of oxazolo[4,5-b]pyridin-2(3H)-one (cf. WO 2010/135014 A1), 0.52 g (3.67 mmol) of 2-chloromethyl-5-methylpyrazine (WO 2008/063867 A2), 1.79 g (5.51 mmol) of cesium carbonate in 50 ml of DMF, 62.5 mg of cesium iodide.

This gives 54.5 mg (5.8% of theory) of 4-(6-chloro-5-fluoropyridin-3-ylmethyl)oxazolo[4,5-b]pyridin-2(4H)-one.

LC-MS (ESI positive): m/z found: 243.2 [M⁺+H].

C₁₂H₁₀N₄O₂ calculated: 242.2.

### Example I-6

### 4-(2-Chloro-1,3-thiazol-5-ylmethyl)oxazolo[4,5-b]pyridin-2(4H)-one

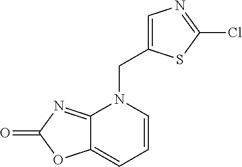 [SMILES: O=c1nc2n(Cc3cnc(Cl)s3)cccc-2o1]

The synthesis was carried out analogously to the reaction procedure of Example I-1 using:

1.00 g (7.34 mmol) of oxazolo[4,5-b]pyridin-2(3H)-one (cf. WO 2010/135014 A1), 1.23 g (7.34 mmol) of 2-chloro-5-chloromethyl-1,3-thiazole (cf. WO 98/32747 A2), 3.59 g (11.02 mmol) of cesium carbonate in 100 ml of DMF, 125 mg of cesium iodide.

This gives 811.0 mg (41.2% of theory) of 4-(2-chloro-1,3-thiazol-5-ylmethyl)oxazolo[4,5-b]pyridin-2(4H)-one.

¹H NMR (600 MHz, DMSO-d₆) δ 5.69 (s, 2H), 6.93-6.96 (m, 1H), 7.46-7.48 (dd, 1H), 7.88 (d, 1H), 7.95-7.96 (dd, 1H) ppm

¹³C with ¹H decoupling (CPD) NMR (150 MHz, DMSO-d₆) δ 47.5 (CH₂), 112.8, 113.0, 130.3, 143.8, 158.8 (hetaryl-C), 152.4 (thiazole-Cl), 133.9, 142.8 (thiazole-C), 162.2 (C═O) ppm

As a further product (compound IV-4), 893.1 mg (45.4% of theory) of 3-(2-chloro-1,3-thiazol-5-ylmethyl)oxazolo[4,5-b]-2(3H)-one were isolated.

LC-MS (ESI positive): m/z found: 268.0 [M⁺+H].

C₁₀H₆ClN₂O₂S calculated: 267.6 g/mol.

### Example I-7

### 4-(1,2,5-Thiadiazol-3-ylmethyl)oxazolo[4,5-b]pyridin-2(4H)-one

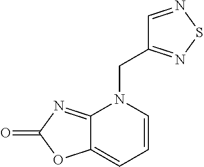 [SMILES: O=c1nc2n(Cc3cnsn3)cccc-2o1]

The synthesis was carried out analogously to the reaction procedure of Example I-1 using:

0.50 g (3.67 mmol) of oxazolo[4,5-b]pyridin-2(3H)-one (cf. WO 2010/135014 A1), 0.59 g (3.67 mmol) of 3-bromomethyl-1,2,5-thiadiazole (cf. preparation S. Mataka et al., J. Heterocycl. Chem. 1984, 21, 1157-1160), 1.79 g (5.51 mmol) of cesium carbonate in 50 ml of DMF, 62.5 mg of cesium iodide.

This gives 265.6 mg (11.2% of theory) of 4-(1,2,5-thiadiazol-3-ylmethyl)oxazolo[4,5-b]pyridin-2(4H)-one.

LC-MS (ESI positive): m/z found: 235.0 [M⁺+H].

C₉H₆N₄O₂S calculated: 234.2 g/mol.

¹H NMR (600 MHz, DMSO-d₆) δ 5.73 (s, 2H), 6.73-6.76 (m, 1H), 7.12-7.13 (m, 1H), 7.47-7.48 (dd, 1H), 8.82 (s, 1H) ppm

¹³C with ¹H decoupling (CPD) NMR (150 MHz, CDCl₃) δ 49.4 (CH₂), 111.5, 112.3, 128.8, 145.0, 160.2 (hetaryl-C), 150.1, 155.6 (thiadiazole-C), 162.7 (C═O) ppm

### Example I-8

### 4-(3-Methylisoxazol-3-ylmethyl)oxazolo[4,5-b]pyridin-2(4H)-one

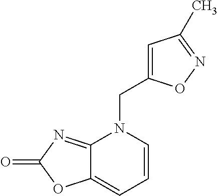 [SMILES: Cc1cc(Cn2cccc3oc(=O)nc2-3)on1]

The synthesis was carried out analogously to the reaction procedure of Example I-1 using: 0.50 g (3.67 mmol) of oxazolo[4,5-b]pyridin-2(3H)-one (cf. WO 2010/135014 A1), 0.64 g (3.67 mmol) of 3-bromomethyl-3-methylisoxazole (cf. preparation DE 2045050 A), 1.79 g (5.51 mmol) of cesium carbonate in 50 ml of DMF, 62.5 mg of cesium iodide.

This gives 250.0 mg (29.4% of theory) of 4-(3-methylisoxazol-3-ylmethyl)oxazolo[4,5-b]pyridin-2(4H)-one.

LC-MS (ESI positive): m/z found: 232.1 [M⁺+H].

C₁₁H₉N₃O₃ calculated: 231.2 g/mol.

### Example I-9

### 4-(6-Fluoropyridin-3-ylmethyl)oxazolo[4,5-b]pyridin-2(4H)-one

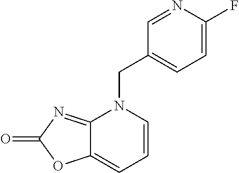 [SMILES: O=c1nc2n(Cc3ccc(F)nc3)cccc-2o1]

The synthesis was carried out analogously to the reaction procedure of Example I-1 using: 0.50 g (3.67 mmol) of oxazolo[4,5-b]pyridin-2(3H)-one (cf. WO 2010/135014 A1), 0.53 g (3.67 mmol) of 5-chloromethyl-2-fluoropyridine, 1.79 g (5.51 mmol) of cesium carbonate in 50 ml of DMF, 62.5 mg of cesium iodide.

This gives 91.1 mg (10.2% of theory) of 4-(6-fluoropyridin-3-ylmethyl)oxazolo[4,5-b]pyridin-2(4H)-one.

LC-MS (ESI positive): m/z found: 246.2 [M⁺+H].

C₁₂H₈FN₃O₂ calculated: 245.0.

### Example I-10

### 4-(6-Bromopyridin-3-ylmethyl)oxazolo[4,5-b]pyridin-2(4H)-one

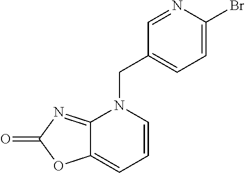 [SMILES: O=c1nc2n(Cc3ccc(Br)nc3)cccc-2o1]

The synthesis was carried out analogously to the reaction procedure of Example I-1 using:

0.78 g (5.73 mmol) of oxazolo[4,5-b]pyridin-2(3H)-one (cf. WO 2010/135014 A1), 1.43 g (5.73 mmol) of 2-bromo-5-chloromethylpyridine, 2.80 g (8.59 mmol) of cesium carbonate in 78 ml of DMF, 97.5 mg of cesium iodide.

This gives 180.1 mg (10.3% of theory) of 4-(6-bromopyridin-3-ylmethyl)oxazolo[4,5-b]pyridin-2(4H)-one.

LC-MS (ESI positive): m/z found: 305.9 [M⁺].

C₁₂H₈BrN₃O₂ calculated: 306.1.

### Example I-11

### 6-Bromo-4-(6-chloropyridin-3-ylmethyl)oxazolo[4,5-b]pyridin-2(4H)-one

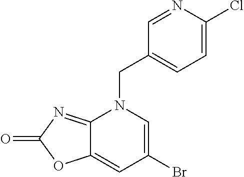 [SMILES: O=c1nc2n(Cc3ccc(Cl)nc3)cc(Br)cc-2o1]

The synthesis was carried out analogously to the reaction procedure of Example I-1 using:

126.0 mg (0.58 mmol) of 6-bromooxazolo[4,5-b]pyridin-2(3H)-one (cf. WO 2004/076412 A2), 94.9 mg (0.58 mmol) of 2-chloro-5-chloromethylpyridine, 286.5 mg (0.87 mmol) of cesium carbonate in 10 ml of DMF,

12.5 mg of cesium iodide.

This gives 32.0 mg (16.0% of theory) of 6-bromo-4-(6-chloropyridin-3-ylmethyl)oxazolo[4,5-b]pyridin-2(4H)-one.

LC-MS (ESI positive): m/z found: 341.9 [M⁺+H].

C₁₂H₇BrClN₃O₂ calculated: 340.5.

### Example I-12

### 6-Bromo-4-(2-chloro-1,3-thiazol-5-ylmethyl)oxazolo[4,5-b]pyridin-2(4H)-one

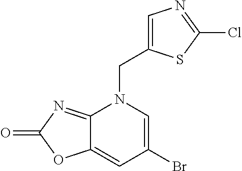 [SMILES: O=c1nc2n(Cc3cnc(Cl)s3)cc(Br)cc-2o1]

The synthesis was carried out analogously to the reaction procedure of Example I-1 using:

62.5 mg (0.29 mmol) of 6-bromooxazolo[4,5-b]pyridin-2(3H)-one (cf. WO 2004/076412 A2), 48.8 mg (0.29 mmol) of 2-chloro-5-chloromethyl-1,3-thiazole (cf. WO 98/32747 A1), 142.0 mg (0.43 mmol) of cesium carbonate in 5 ml of DMF, 6.2 mg of cesium iodide.

This gives 7.3 mg (7.2% of theory) of 6-bromo-4-(2-chloro-1,3-thiazol-5-ylmethyl)oxazolo[4,5-b]pyridin-2(4H)-one.

LC-MS (ESI positive): m/z found: 347.9 [M⁺+H].

C₁₀H₅BrClN₃O₂S calculated: 346.5.

### Example I-13

### 6-Chloro-4-(6-chloropyridin-3-ylmethyl)oxazolo[4,5-b]pyridin-2(4H)-one

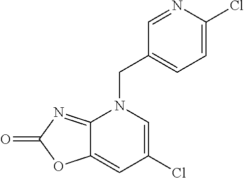 [SMILES: O=c1nc2n(Cc3ccc(Cl)nc3)cc(Cl)cc-2o1]

The synthesis was carried out analogously to the reaction procedure of Example I-1 using:

100.0 mg (0.58 mmol) of 6-chlorooxazolo[4,5-b]pyridin-2(3H)-one (cf. WO 2007/022257 A2), 94.9 mg (0.58 mmol) of 2-chloro-5-chloromethylpyridine, 286.5 mg (0.87 mmol) of cesium carbonate in 10 ml of DMF, 12.5 mg of cesium iodide.

This gives 16.4 mg (9.4% of theory) of 6-chloro-4-(6-chloropyridin-3-ylmethyl)oxazolo[4,5-b]pyridin-2(4H)-one.

LC-MS (ESI positive): m/z found: 296.0 [M⁺].

C₁₂H₇Cl₂N₃O₂ calculated: 296.1.

### Example I-14

### 6-Chloro-4-(2-chloro-1,3-thiazol-5-ylmethyl)oxazolo[4,5-b]pyridin-2(4H)-one

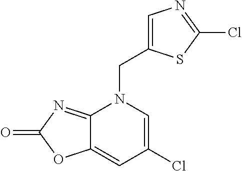 [SMILES: O=c1nc2n(Cc3cnc(Cl)s3)cc(Cl)cc-2o1]

The synthesis was carried out analogously to the reaction procedure of Example I-1 using:

183.0 mg (1.07 mmol) of 6-chlorooxazolo[4,5-b]pyridin-2(3H)-one (cf. WO 2007/022257 A2), 180.3 mg (1.07 mmol) of 2-chloro-5-chloromethyl-1,3-thiazole (cf. WO 98/32747 A1), 524.3 mg (1.60 mmol) of cesium carbonate in 18.3 ml of DMF, 22.8 mg of cesium iodide.

This gives 56.9 mg (17.5% of theory) of 6-chloro-4-(2-chloro-1,3-thiazol-5-ylmethyl)-oxazolo[4,5-b]pyridin-2(4H)-one.

LC-MS (ESI positive): m/z found: 302.0 [M⁺].

C₁₀H₅Cl₂N₃O₂S calculated: 302.1.

### Example I-15

### (R,S)-4-[1-(6-Chloropyridin-3-yl)ethyl]oxazolo[4,5-b]pyridin-2(4H)-one

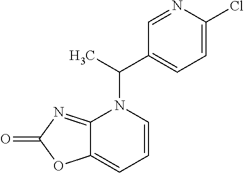 [SMILES: CC(c1ccc(Cl)nc1)n1cccc2oc(=O)nc1-2]

The synthesis was carried out analogously to the reaction procedure of Example I-1 using:

0.50 g (3.67 mmol) of oxazolo[4,5-b]pyridin-2(3H)-one (cf. WO 2010/135014 A1), 0.64 g (3.67 mmol) of 2-chloro-5-[(1R,S)-1-chloroethyl]pyridine, 1.8 g (5.51 mmol) of cesium carbonate in 50 ml of DMF, 62.5 mg of cesium iodide.

This gives 55.0 mg (5.4% of theory) of 4-[1-(6-chloropyridin-3-yl)ethyl]oxazolo[4,5-b]pyridin-2(4H)-one.

LC-MS (ESI positive): m/z found: 276.0 [M⁺+H].

C_H₁₀ClN₃O₂ calculated: 275.6.

### Example I-16

### 4-(6-Chloropyridin-3-ylmethyl)-5,6,7,7a-tetrahydrooxazolo[4,5-b]-pyridin-2(4H)-one

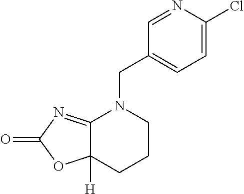 [SMILES: O=C1N=C2C(CCCN2Cc2ccc(Cl)nc2)O1]

### Variant A:

25 mg of cesium iodide were added to a stirred solution of 200 mg (1.42 mmol) of a mixture of 5,6,7,7a-tetrahydrooxazolo[4,5-b]-pyridin-2(4H)-one and oxazolo[4,5-b]pyridin-2(3H)-one (cf. WO 2010/135014 A1), 231.2 mg (1.42 mmol) of 2-chloro-5-chloromethylpyridinepyridine, 697.4 mg (2.14 mmol) of cesium carbonate in 20 ml of DMF. The entire reaction mixture was then stirred at room temperature for about 48 hours. The reaction mixture was then filtered and concentrated under reduced pressure, and the residue that remained is purified chromatographically by middle-pressure chromatography (RP phase; water/acetonitrile-water gradient). This gives 23.9 mg (6.1% of theory) as an about (1:1) mixture of 4-(6-chloropyridin-3-ylmethyl)-5,6,7,7a-tetrahydrooxazolo[4,5-b]-pyridin-2(4H)-one and 4-(6-chloropyridin-3-ylmethyl)oxazolo[4,5-b]pyridin-2(4H)-one (cf. Example I-3 including analytical data).

LC-MS (ESI positive): m/z found: 266.1 [M⁺+H].

C₁₂H₁₂ClFN₃O₂ calculated: 265.7.

¹³C with ¹H decoupling (CPD) NMR (150 MHz, DMF-d₆) δ 18.9, 24.4, 46.7, 50.4 (CH₂), 75.0 (CH), 150.9 (Py-CCl), 125.1, 132.0, 140.3, 150.5 (Py-C), 167.5 (C═O), 183.1 (C═N) ppm

As a further byproduct (compound I-16a), 16.6 mg (2.7% of theory) of 2-[(N-acetyl, N′-(6-chloropyridin-3-ylmethyl)amino)]-3-(6-chloropyridin-3-ylmethoxy)pyridine were isolated.

LC-MS (ESI positive): m/z found: 403.1 [M⁺].

C₁₉H₁₆Cl₂N₄O₂ calculated: 403.2.

¹³C with ¹H decoupling (CPD) NMR (150 MHz, DMF-d₆) δ 22.1 (CH₃), 67.0 (OCH₂), 47.8 (NCH₂), 122.9, 124.4, 125.1, 125.7, 132.2, 134.2, 140.0, 140.1, 141.6, 145.4, 150.1, 150.2, 150.5 (Py-CH), 150.0, 151.3 (Py-CCl), 170.6 (C═O) ppm

As a further byproduct (compound I-16b), 4.9 mg (0.9% of theory) of 6-chloropyridin-3-yl 4-[(N-cyano, N′-(6-chloropyridin-3-ylmethyl)amino)]butanoate were isolated.

LC-MS (ESI positive): m/z found: 479.8 [M⁺+H].

C₁₇H₁₆Cl₂N₄O₂ calculated: 378.0.

¹³C with ¹H decoupling (CPD) NMR (150 MHz, DMF-d₆) δ 23.5, 30.9, 51.0 (CH₂), 63.3 (OCH₂), 52.1 (NCH₂), 124.9, 125.2, 132.0, 132.6, 140.3, 140.9, 150.4, 150.9, (Py-CH), 151.1, 151.4 (Py-CCl), 117.6 (CN), 173.0 (C═O) ppm

### Variant B:

The synthesis was carried out analogously to the reaction procedure of variant A using:

232.5 mg (1.65 mmol) of 5,6,7,7a-tetrahydrooxazolo[4,5-b]-pyridin-2(4H)-one, 268.8 mg (1.65 mmol) of 2-chloro-5-chloromethylpyridine, 810.8 mg (2.48 mmol) of cesium carbonate in 23.2 ml of DMF, 29.0 mg of cesium iodide.

This gives 17.9 mg (3.9% of theory) of pure 4-(6-chloropyridin-3-ylmethyl)-5,6,7,7a-tetrahydrooxazolo[4,5-t]-pyridin-2(4H)-one (purity: 97.1%; LC-MS).

### Example I-17

### 4-(Tetrahydrofur-3-ylmethyl)oxazolo[4,5-b]pyridin-2(4H)-one

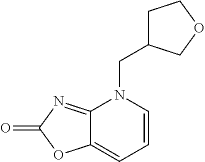 [SMILES: O=c1nc2n(CC3CCOC3)cccc-2o1]

The synthesis was carried out analogously to the reaction procedure of Example I-1 using:

0.50 g (3.67 mmol) of oxazolo[4,5-b]pyridin-2(3H)-one (cf. WO 2010/135014 A1), 0.60 g (3.67 mmol) of 3-(bromomethyl)tetrahydrofuran (cf. EP 649845 A1), 1.79 g (5.51 mmol) of cesium carbonate in 50 ml of DMF, 62.5 mg of cesium iodide.

This gives 30.1 mg (3.7% of theory) of 4-(tetrahydrofur-3-ylmethyl)-oxazolo[4,5-b]pyridin-2(4H)-one.

LC-MS (ESI positive): m/z found: 221.1 [M⁺+H].

C₁₁H₁₂N₂O₃ calculated: 220.2.

As a further product (compound IV-5), 160.0 mg (19.7% of theory) of 3-(tetrahydrofur-3-ylmethyl)oxazolo[4,5-b]-2(3H)-one were isolated.

LC-MS (ESI positive): m/z found: 221.1 [M⁺+H].

C₁₁H₁₂N₂O₃ calculated: 220.2.

### Example I-18

### 7-Methyl-4-(6-chloropyridin-3-ylmethyl)oxazolo[4,5-b]pyridin-2(4H)-one

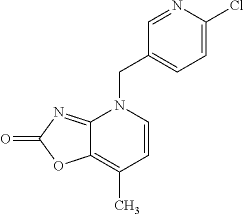 [SMILES: Cc1ccn(Cc2ccc(Cl)nc2)c2nc(=O)oc1-2]

The synthesis was carried out analogously to the reaction procedure of Example I-1 using:

0.42 g (2.81 mmol) of 7-methyloxazolo[4,5-b]pyridin-2(3H)-one, 0.45 g (2.81 mmol) of 2-chloro-5-chloromethylpyridine, 1.37 g (4.22 mmol) of cesium carbonate in 38.4 ml of DMF, 47.9 mg of cesium iodide.

This gives 14.6 mg (1.88% of theory) of 7-methyl-4-(6-chloropyridin-3-ylmethyl)oxazolo[4,5-b]pyridin-2(4H)-one.

LC-MS (ESI positive): m/z found: 276.0 [M⁺].

C₁₃H₁₀ClN₃O₂ calculated: 275.6.

As a further product (compound IV-6), 85.0 mg (10.1% of theory) of 7-methyl-3-(6-chloropyridin-3-ylmethyl)oxazolo[4,5-b]-2(3H)-one were isolated.

LC-MS (ESI positive): m/z found: 276.0 [M+].

C₁₃H₁₀ClN₃O₂ calculated: 275.6.

### Synthesis of the Starting Materials of the Formula (II)

### Example II-1

### Oxazolo[4,5-b]-5,6,7,7a-tetrahydropyridin-2(4H)-one

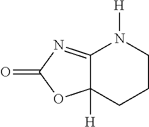

### 1^{st} Step/Variant A

### Acetate of 2-amino-3,4,5,6-tetrahydropyridin-2-ol (cf. also WO 95/11231 A1)

15.6 g (141.6 mmol) of 2-amino-3-hydroxypyridine are initially charged in 300 ml of glacial acetic acid,
5.1 g of 5% rhodium/carbon catalyst are added and the mixture is hydrogenated in a 600 ml vessel (material: Hastelloy) at room temperature (20° C.) at 4.5 bar for about 16 hours. The entire reaction mixture is then filtered (removal of the catalyst) and concentrated under reduced pressure, and the residue that remains is recrystallized from an ethanol/ether mixture. This gives 5.9 g (23.9% of theory) of a (2:1) mixture of 2-amino-3-hydroxypyridine and 2-amino-3,4,5,6-tetrahydropyridin-2-ol acetate CH NMR spectrum: some Py-H) which can be used for the next reaction.

¹H NMR (600 MHz, D₂O) δ 1.79 (br., m, 1H), 1.90-1.92 (m, 1H), 1.99-2.00 (br., m, 1H), 2.22 (br., m, 1H), 3.37 (m, 2H), 4.52 (m, 1H), 6.77-6.78 (m, 1H), 7.18-7.19 (m, 1H), 7.28-7.29 (m, 1H) ppm

### Variant B:

The hydrogenation was carried out according to the reaction procedure (1^{st} step/variant A) in a 600 ml vessel (material: Hastelloy) at room temperature (20° C.) [time: about 48 hours, pressure: 10 bar] using:

15.6 g (141.6 mmol) of 2-amino-3-hydroxypyridine, 5.1 g of 5% rhodium/carbon catalyst,

300 ml of glacial acetic acid.

This gives 13.9 g (56.5% of theory) of pure 2-amino-3,4,5,6-tetrahydropyridin-2-ol acetate (¹H NMR spectrum: no more Py-H signals observed) which can be used for the next reaction.

### 2^{nd} step/variant A: Oxazolo[4,5-b]-5,6,7,7a-tetrahydropyridin-2(4H)-one

At room temperature, 1.0 g (5.74 mmol) of the (2:1) mixture of 2-amino-3-hydroxypyridine and 2-amino-3,4,5,6-tetrahydropyridin-2-ol acetate (cf. step 1) are stirred with 1.26 g (7.79 mmol) of 1,1′-carbonyldiimidazole (CDI), 39.9 mg of 4-dimethylaminipyridine (DMAP) in 6 ml of dichloromethane, and 1.2 ml of triethylamine are added. The entire reaction mixture is then stirred at room temperature for another about 24 hours. The reaction mixture is then concentrated under reduced pressure, the residue that remains is taken up in ethyl acetate and the organic phase is washed with water. The organic phase is separated off and then dried over sodium sulfate, filtered and concentrated under reduced pressure. The residue that remains is purified chromatographically by medium-pressure chromatography (cyclohexane/acetone gradient). This gives 753.0 mg (93.2% of theory) of a mixture of oxazolo[4,5-b]-5,6,7,7a-tetrahydropyridin-2(4H)-one

and oxazolo[4,5-b]pyridin-2(3H)-one (cf. WO 2010/135014 A1) (¹H NMR spectrum: some Py-H and LC-MS m/z: 137.0) which can be used for the next reaction.

LC-MS (ESI positive): m/z found: 141.0 [M⁺+H].

C₆H₈N₂O₂ calculated: 140.0.

### Variant B:

The ring closure reaction was carried out according to the reaction procedure (2^{nd} step/variant A) using:

1.00 g (5.74 mmol) of 2-amino-3-hydroxypyridine, 1.26 g (7.79 mmol) of CDI, 39.9 mg (0.32 mmol) of DMAP in 6 ml of dichloromethane, 1.2 ml of triethylamine.

This gives 232.5 mg (28.9% of theory) of pure oxazolo[4,5-b]-5,6,7,7a-tetrahydropyridin-2(4H)-one which can be used for the next reaction.

### Example II-2

### 7-Methyloxazolo[4,5-b]pyridin-2(3H)-one

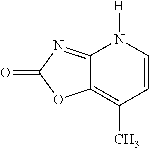

The synthesis was carried out analogously to the reaction procedure of Example II-1 using:

910.0 mg (7.33 mmol) of 2-amino-4-methyl-3-pyridinol (cf. CH 452528), 1612.9 mg (7.79 mmol) of CDI, 51.0 mg (0.41 mmol) of DMAP in dichloromethane and triethylamine.

This gives 383.5 mg (33.8% of theory) of 7-methyloxazolo[4,5-b]pyridin-2(3H)-one which can be used for the next reaction.

### B: BIOLOGICAL EXAMPLES

### 1. Phaedon Test (PHAECO Spray Treatment)

Solvents: 78.0 parts by weight of acetone
1.5 parts by weight of dimethylformamide
   Emulsifier: 0.5 part by weight of alkylaryl polyglycol ether

To produce a suitable preparation of active compound, 1 part by weight of active compound is mixed with the stated amounts of solvent and emulsifier, and the concentrate is diluted with emulsifier-containing water to the desired concentration.

Disks of Chinese cabbage leaves (Brassica pekinensis) are sprayed with an active compound preparation of the desired concentration and, after drying, populated with larvae of the mustard beetle (Phaedon cochleariae).

After 7 days, the effect in % is determined. 100% means that all beetle larvae have been killed; 0% means that none of the beetle larvae have been killed.

In this test, for example, the following compounds of the Preparation Examples show, at an application rate of 500 g/ha, an effect of 100%: I-2, I-3, I-4, I-6, I-10, I-16

### 2. Myzus Test (MYZUPE Spray Treatment)

Solvents: 78.0 parts by weight of acetone
1.5 parts by weight of dimethylformamide
   Emulsifier: 0.5 part by weight of alkylaryl polyglycol ether

To produce a suitable preparation of active compound, 1 part by weight of active compound is mixed with the stated amounts of solvent and emulsifier, and the concentrate is diluted with emulsifier-containing water to the desired concentration.

Disks of Chinese cabbage leaves (Brassica pekinensis) infested by all stages of the green peach aphid (Myzus persicae) are sprayed with an active compound preparation of the desired concentration.

After 6 days, the effect in % is determined. 100% means that all of the aphids have been killed; 0% means that none of the aphids have been killed.

In this test, for example, the following compounds of the Preparation Examples show, at an application rate of 500 g/ha, an effect of 100%: I-1, I-2, I-3, I-4, I-5, I-6, I-9, I-10, I-11, I-16, IV-2

In this test, for example, the following compounds of the Preparation Examples show, at an application rate of 500 g/ha, an effect of 90%: IV-I

### 3. Tetranychus Test, OP-Resistant (TETRUR Spray Treatment)

Solvents: 78.0 parts by weight of acetone
1.5 parts by weight of dimethylformamide
   Emulsifier: 0.5 part by weight of alkylaryl polyglycol ether

To produce a suitable preparation of active compound, 1 part by weight of active compound is mixed with the stated amounts of solvent and emulsifier, and the concentrate is diluted with emulsifier-containing water to the desired concentration.

Disks of bean leaves (Phaseolus vulgaris) which are infested by all stages of the greenhouse red spider mite (Tetranychus urticae) are sprayed with an active compound preparation of the desired concentration.

After 6 days, the effect in % is determined. 100% here means that all of the spider mites have been killed. 0% means that none of the spider mites have been killed.

In this test, for example, the following compounds of the Preparation Examples show, at an application rate of 100 g/ha, an effect of 100%: I-16

In this test, for example, the following compounds of the Preparation Examples show, at an application rate of 100 g/ha, an effect of 90%: I-16a

### 4. Ctenocephalides felis; Oral (CTECFE)

Solvents: 1 part by weight of dimethyl sulfoxide

To produce a suitable preparation of active compound, 10 mg of active compound are mixed with 0.5 ml of dimethyl sulfoxide. A portion of the concentrate is diluted with citrated cattle blood, and the desired concentration is prepared.

About 20 unfed adult fleas (Ctenocephalides felis) are placed into a chamber which is closed at the top and bottom with gauze. A metal cylinder whose bottom end is closed with parafilm is placed onto the chamber. The cylinder contains the blood/active compound preparation, which can be taken up by the fleas through the parafilm membrane.

After 2 days, the kill in % is determined 100% means that all of the fleas have been killed; 0% means that none of the fleas have been killed.

In this test, for example, the following compounds of the Preparation Examples show an effect of 80% at an application rate of 100 ppm: I-6

### 5. Lucilia cuprina Test (LUCICU)

Solvent: dimethyl sulfoxide

To produce a suitable preparation of active compound, 10 mg of active compound are mixed with 0.5 ml of dimethyl sulfoxide, and the concentrate is diluted with water to the desired concentration.

Vessels containing horse meat treated with the active compound preparation of the desired concentration are populated with about 20 Lucilia cuprina larvae.

After 48 hours, the kill in % is determined 100% means that all larvae have been killed; 0% means that no larvae have been killed.

In this test, for example, the following compounds of the Preparation Examples show an effect of 100% at an application rate of 100 ppm: I-2, I-3, I-4, I-6, I-9

### 6. Musca domestica Test (MUSCDO)

Solvent: dimethyl sulfoxide

To produce a suitable preparation of active compound, 10 mg of active compound are mixed with 0.5 ml of dimethyl sulfoxide, and the concentrate is diluted with water to the desired concentration.

Vessels containing a sponge treated with the active compound formulation of the desired concentration are populated with adult Musca domestica.

After 2 days, the kill in % is determined. 100% means that all of the flies have been killed; 0% means that none of the flies have been killed.

In this test, for example, the following compounds of the Preparation Examples show an effect of 80% at an application rate of 100 ppm: I-4

### 7. Cooperia curticei Test (COOPCU)

Solvent: dimethyl sulfoxide

To produce a suitable preparation of active compound, 10 mg of active compound are mixed with 0.5 ml of dimethyl sulfoxide, and the concentrate is diluted with Ringer solution to the desired concentration. Vessels containing the active compound preparation of the desired concentration are populated with about 40 Cooperia curticei larvae.

After 5 days, the kill in % is determined. 100% means that all larvae have been killed; 0% means that no larvae have been killed.

In this test, for example, the following compounds of the Preparation Examples show an effect of 80% at an application rate of 100 ppm: I-3

1. A bicyclic (thio)carbonylamidine of formula (I) 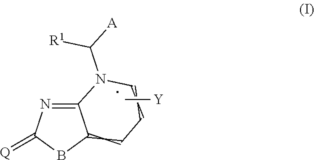
in which
Q represents oxygen or sulfur;
B represents oxygen, sulfur, methylene, difluoromethylene, or optionally substituted nitrogen;
Y represents a radical selected from a group consisting of hydrogen, cyano, halogen (for example fluorine, chlorine, bromine or iodine), C₁-C₆-alkoxy, C₁-C₆-haloalkoxy, C₁-C₆-alkylthio, C₁-C₆-haloalkylthio, C₁-C₆-alkylsulfinyl, C₁-C₆-haloalkylsulfinyl, C₁-C₆-alkylsulfonyl and C₁-C₆-haloalkylsulfonyl, C₁-C₆-alkyl, C₁-C₆-haloalkyl, C₂-C₆-alkenyl, C₂-C₆-haloalkenyl, C₂-C₆-alkynyl, C₂-C₆-haloalkynyl, nitro, amino, C₁-C₆-alkylamino, di(C₁-C₆-alkyl)amino, C₁-C₆-alkylcarbonylamino, C₁-C₆-alkoxycarbonylamino, C₃-C₆-cycloalkyl-C₁-C₆-alkyl, C₃-C₆-cycloalkyl, C₁-C₆-alkylcarbonyl and C₁-C₆-alkoxycarbonyl;
R¹ represents hydrogen or C₁-C₆-alkyl;
A represents a hetaryl radical selected from a group consisting of pyrrolyl, pyrazolyl, imidazolyl, 1,2,3-triazolyl, 1,2,4-triazolyl, tetrazolyl, oxazolyl, isoxazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, 1,2,5-thiadiazolyl, pyridyl, pyrimidinyl, pyridazinyl and pyrazinyl, where each of these hetaryl radicals may be substituted by at least one substituent X selected from a group consisting of fluorine, chlorine, bromine, iodine, cyano, nitro, C₁-C₄-alkyl, C₁-C₄-haloalkyl, C₁-C₃-alkylthio, C₁-C₃-haloalkylthio, C₁-C₃-alkylsulfonyl, C₁-C₃-haloalkylsulfonyl, or represents heterocyclyl from the group consisting of tetrahydrofur-3-yl or tetrahydrothien-3-yl; where the substructure 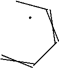
represents a system which optionally comprises at least one double bond, where the bond between the crossed line is a double bond or at least one or more of the crossed lines are double bonds,
with the proviso that 4-(2′-pyridylmethyl)oxazolo[4,5-b]pyridin-2-(4H)-one, which is known from CH 461 489, is excluded.

2. The bicyclic (thio)carbonylamidine of formula (I) as claimed in claim 1,
in which
Q represents oxygen;
B represents oxygen or methylene;
Y represents a radical selected from a group consisting of hydrogen, cyano, halogen (for example fluorine, chlorine, bromine or iodine), C₁-C₆-alkoxy, C₁-C₆-haloalkoxy, C₁-C₆-alkylthio, C₁-C₆-haloalkylthio, C₁-C₆-alkylsulfinyl, C₁-C₆-haloalkylsulfinyl, C₁-C₆-alkylsulfonyl and C₁-C₆-haloalkylsulfonyl, C₁-C₆-alkyl, C₁-C₆-haloalkyl, C₂-C₆-alkenyl, C₂-C₆-haloalkenyl, C₂-C₆-alkynyl, C₂-C₆-haloalkynyl, nitro, amino, C₁-C₆-alkylamino, di(C₁-C₆-alkyl)amino, C₁-C₆-alkylcarbonylamino, C₁-C₆-alkoxycarbonylamino, C₃-C₆-cycloalkyl-C₁-C₆-alkyl, C₃-C₆-cycloalkyl, C₁-C₆-alkylcarbonyl and C₁-C₆-alkoxycarbonyl;
R¹ represents hydrogen or C₁-C₆-alkyl; and
A is selected from a group consisting of thiazol-5-yl which is substituted in the 2-position by fluorine, chlorine, bromine, iodine, C₁-C₄-alkyl or C₁-C₄-haloalkyl, represents isoxazol-5-yl which is substituted in the 3-position by fluorine, chlorine, bromine, iodine, C₁-C₄-alkyl, C₁-C₄-haloalkyl, C₁-C₄-haloalkoxy or cyano, represents oxazol-5-yl which is substituted in the 2-position by fluorine, chlorine, bromine, iodine, C₁-C₄-alkyl, C₁-C₄-haloalkyl, C₁-C₄-haloalkoxy or cyano, represents 1,2,5-thiadiazol-3-yl or represents tetrahydrofur-3-yl, pyrid-3-yl which is substituted in the 6-position by fluorine, chlorine, bromine, iodine, C₁-C₄-alkyl or C₁-C₄-haloalkyl, pyrimidin-5-yl which is substituted in the 2-position by fluorine, chlorine, bromine, iodine oder C₁-C₄-alky, pyrazin-2-yl which is substituted in the 2-position by fluorine, chlorine, bromine, iodine or C₁-C₄-alkyl and pyrid-3-yl which is substituted in the 5-position by fluorine, chlorine, bromine, iodine, C₁-C₄-alkyl, C₁-C₄-haloalkyl, C₁-C₄-haloalkoxy, azido or cyano and is substituted in the 6-position by fluorine, chlorine, bromine, iodine, C₁-C₄-alkyl or C₁-C₄-haloalkyl.

3. The bicyclic (thio)carbonylamidine of formula (I) as claimed in claim 1,
in which
Q represents oxygen;
B represents oxygen or methylene;
Y represents hydrogen or halogen;
R¹ represents hydrogen or C₁-C₆-alkyl; and
A is selected from a group consisting of 6-chloropyrid-3-yl, 6-trifluoromethylpyrid-3-yl, 6-fluoropyrid-3-yl, 6-bromopyrid-3-yl, 1,2,5-thiadiazol-3-yl, 5-methylpyrazin-2-yl, 2-chloro-1,3-thiazol-5-yl, 2-methyl-1,3-thiazol-5-yl, 2-methoxy-1,3-thiazol-5-yl, 2-bromo-1,3-thiazol-5-yl, 3-trifluoromethyl-1,3-thiazol-5-yl, 3-chloroisoxazol-5-yl, 3-methylisoxazol-5-yl, tetrahydrofur-3-yl, 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl or 5-difluoromethyl-6-iodopyrid-3-yl.

4. The bicyclic (thio)carbonylamidine of formula (I) as claimed in claim 1 comprising at least one of formulae (I-a) to (I-q)

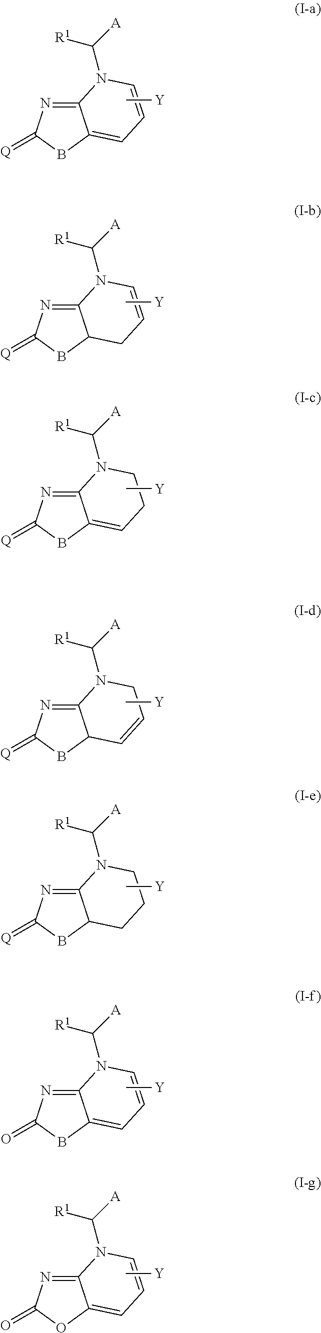

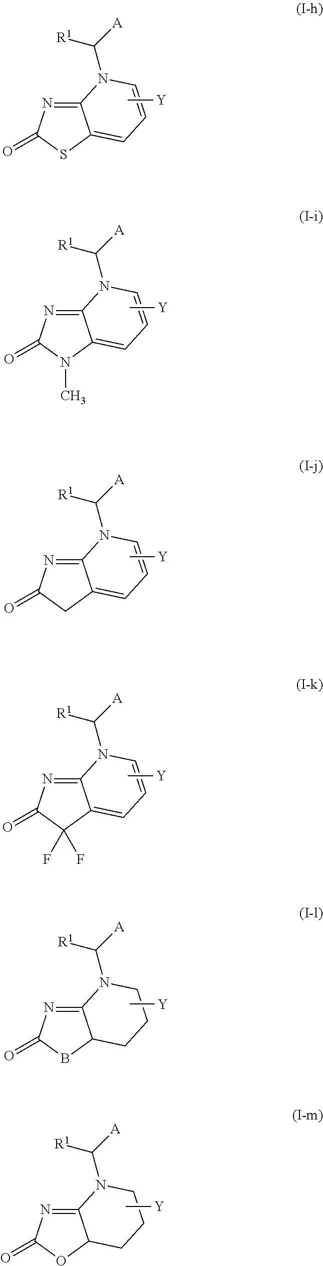

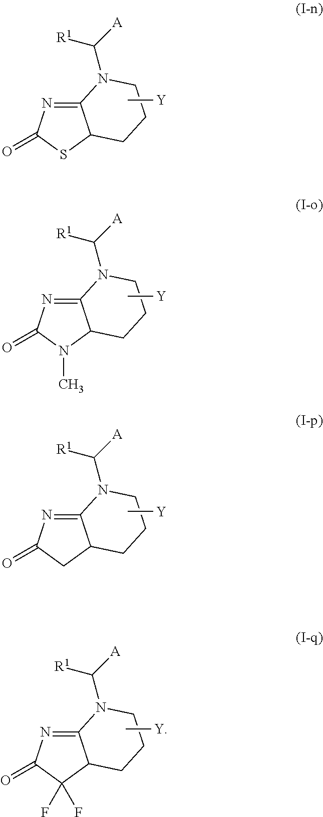

5. A process for preparing a bicyclic (thio)carbonylamidine of formula (I) as defined in claim 1, comprising reacting a compound of formula (IIa) and/or (IIb) 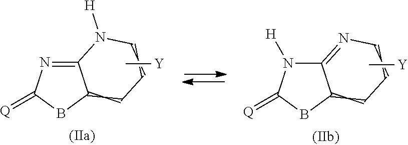
with a compound of formula (III) 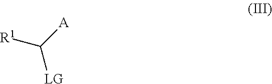
in which
LG represents a nucleofugic leaving group, optionally generated in situ, selected from the group consisting of halogen, O-tosyl, O-mesyl and N-morpholino
in the presence of a diluent and optionally in the presence of a basic reaction auxiliary.

6. The process as claimed in claim 5, in which the diluent is selected from the group consisting of amides, formamide, N-methylformamide, N,N-dimethylformamide, N,N-dipropylformamide, N,N-dibutylformamide, and N-methylpyrrolidine.

7. The process as claimed in claim 5, in which the basic reaction auxiliary employed is an acid binder or an acid binder mixture selected from the group consisting of halides, hydroxides, hydrides, oxides and carbonates of lithium, sodium, potassium, magnesium, calcium and barium, basic compounds, amidine bases, guanidine bases, 7-methyl-1,5,7-triazabicyclo(4.4.0)dec-5-ene (MTBD); diazabicyclo(4.3.0)nonene (DBN), diazabicyclo(2.2.2)octane (DABCO), 1,8-diazabicyclo(5.4.0)undecene (DBU), cyclohexyltetrabutylguanidine (CyTBG), cyclohexyltetramethylguanidine (CyTMG), N,N,N,N-tetramethyl-1,8-naphthalenediamine, pentamethylpiperidine, tertiary amines, triethylamine, trimethylamine, tribenzylamine, triisopropylamine, tributylamine, tricyclohexylamine, triamylamine, trihexylamine, N,N-dimethylaniline, N,N-dimethyltoluidine, N,N-dimethyl-p-aminopyridine, N-methylpyrrolidine, N-methylpiperidine, N-methylimidazole, N-methylpyrazole, N-methylmorpholine, N-methylhexamethylenediamine, pyridine, 4-pyrrolidinopyridine, 4-dimethylaminopyridine, quinoline, α-picoline, β-picoline, isoquinoline, pyrimidine, acridine, N,N,N′,N′-tetramethylenediamine, N,N′,N′-tetraethylenediamine, quinoxaline, N-propyldiisopropylamine, N-ethyldiisopropylamine, N,N′-dimethylcyclohexylamine, 2,6-lutidine, 2,4-lutidine or triethyldiamine, sodium carbonate, potassium carbonate, cesium carbonate, NaCl, NaF, NaI, NaBr, KCl, KF, KI, KBr, CsCl, CsF, CsI and CsBr.

8. A bicyclic (thio)carbonylamidine as defined in claim 1 capable of being used for at least one of the following: for protecting a plant and/or a plant organ, and/or for increasing harvest yield, and/or for improving quality of harvested material and/or for controlling an insect, an arachnid, a helminth, a nematode and/or a mollusc, which is encountered in agriculture, in horticulture, in forests, in gardens and/or leisure facilities, and/or for protection of stored products and/or materials, and/or in a hygiene sector.

9. A bicyclic (thio)carbonylamidine as claimed in claim 8, capable of being used for protecting a seed of a conventional and/or transgenic plant.

10. A crop protection agent comprising at least one bicyclic (thio)carbonylamidine as defined in claim 1.

11. The crop protection agent as claimed in claim 10, additionally comprising at least one further agrochemically active compound selected from the group consisting of insecticides, fungicides, herbicides and safeners.

12. A method for protecting a plant, a plant part and/or a seed comprising applying at least one bicyclic (thio)carbonylamidine as defined in claim 1 to foliage of a plant and/or to a seed.
